(19) United States
(12) Patent Application Publication
(10) Pub. No.: US 2015/0088925 A1
(43) Pub. Date: Mar. 26, 2015

(54) USER INTERFACE FOR PIVOT VIEWS

(71) Applicant: Oracle International Corporation, Redwood Shores, CA (US)

(72) Inventors: Balaji Pattabhiraman, Bangalore (IN); Rahul Mahashabde, Bangalore (IN); Kalpana Madhalam, Trivandrum (IN); Deepankar Narayanan, Trivandrum (IN); Virad Gupta, Fremont, CA (US); Raghu Hanumanthaiah Edalur, San Ramon, CA (US)

(21) Appl. No.: 14/337,230

(22) Filed: Jul. 22, 2014

Related U.S. Application Data
(60) Provisional application No. 61/880,292, filed on Sep. 20, 2013.

(51) Int. Cl. G06F 3/0484; G06F 3/0482; G06F 17/30

(52) U.S. Cl. CPC G06F 3/04842; G06F 17/30424; G06F 17/30339; G06F 3/0482
USPC 707/769; 715/771

(57) ABSTRACT

An aspect of the present disclosure enables a user to specify a first pivot view as a publisher upon change of a criteria for selection of data points, and a second pivot view as a subscriber upon occurrence of the change. When an event representing a change of the criteria in the first view is detected, both the first view and the second view are updated reflecting the change in the selection criteria. According to another aspect of the present invention the formation of elements of a pivot view is based a GROUP BY and a ROLLUP construct. According to yet another aspect, a user can modify the axis for a pivot chart, and an updated chart, corresponding to the modified axis, is displayed.

### PRIORITY CLAIM

The present application is a non-provisional of and claims priority from co-pending U.S. provisional application No. 61/880,292; Entitled: “USER INTERFACE FOR PIVOT VIEWS”, Filed on: 20 Sep. 2013, first named inventor: Balaji Pattabhiraman, and is incorporated in its entirety into the present application.

### BACKGROUND OF THE DISCLOSURE

1. Technical Field

The present disclosure relates to data visualization and more specifically to user interfaces for pivot views.

2. Related Art

Pivot views are defined on top of base tables, and operate to provide a summary or consolidated (e.g., sum, average, etc.) view of the data points in the base tables. For example, a base table may store the details of sales on a daily basis, while a pivot view may provide consolidated information such as aggregate sales by month, average sales per month or by sales person, etc., as is well known in the relevant arts. In addition, some of the pivot views may be based on a subset of the sales transactions (e.g., by region, duration, sales-person, or combination), normally by application of appropriate filters as is also well known in the relevant arts.

Pivot view may be provided associated with complex business intelligence software to simple Spreadsheets, as is also well known in the relevant arts. In general, users specify criteria (e.g., a condition to be satisfied) for selection of desired data points, the manner (monthly summary, average, etc.) in which such selected data points are to be consolidated/summarized, and the form (table/grid, chart, etc.) in which the resulting output is to be displayed.

It is generally desirable that user interfaces be convenient for users to use pivot views.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2A depicts the schema/structure of an example table from a data store.

FIG. 2B depicts screenshot containing two pivots views.

FIG. 3 is a flow chart illustrating the manner in which users may interact with pivot views according to an aspect of the present disclosure.

FIGS. 4 and 5 together illustrate the manner in which a user can specify a pivot view as a publisher upon change of criteria for selection of data points.

FIG. 6 illustrates the manner in which a user can specify a pivot view as a subscriber.

FIG. 7 depicts a user selecting a specific value for Supervisor filter in a first pivot view.

FIG. 8 depicts the first and second pivot views updated in response to a previously configured change on the first pivot view.

FIG. 9 is a block diagram illustrating the details of a server system in an embodiment.

FIG. 10 depicts the structure of and part of the data stored in a base table storing the individual data elements forming the basis for various pivot views.

FIG. 11 depicts the schema for a pivot view in an embodiment.

FIG. 12 is a flow chart illustrating the manner in which pivot view is formed using two database queries.

FIG. 13A depicts the data elements retrieved upon execution of the first query.

FIG. 13B contains the respective list of unique values for each of the row/column axes and filter fields.

FIG. 14 depicts cell set entries generated, for use case 1.

FIGS. 15A-15D together depicts the output of the second query, for use case 1.

FIG. 16 depicts the relevant values from the output extracted, for use case 1.

FIG. 17 depicts cell set with corresponding fact values, for use case 1.

FIG. 18 shows the corresponding pivot view display, for use case 1.

FIG. 19 depicts the cell set, for use case 2.

FIG. 20 depicts the records of interest extracted from the output of the second query, for use case 2.

FIG. 21 depicts the cell set with corresponding fact values assigned, for use case 2.

FIG. 22 shows the corresponding pivot view display, for use case 2.

FIG. 23 shows Biller field getting dragged as a row axis, for use case 3.

FIG. 24 shows the corresponding pivot view display, for use case 3.

FIG. 25 shows Status field getting dragged as a column axis, for use case 4.

FIG. 26 shows the corresponding pivot view display, for use case 4.

FIG. 27 depicts the manner in which a user can initiate modification of axis/axes for a pivot view.

FIG. 28 depicts a grid format for a pivot chart.

FIG. 29 depicts the modified grid format after changes to axes/filters.

FIG. 30 depicts a pivot view corresponding to a modified grid format.

FIG. 31 depicts another pivot chart.

FIG. 32 depicts a grid format, while a user modifies axes/filters for a pivot chart.

FIG. 33A depicts a modified grid format after changes to axes/filters.

FIG. 33B depicts a pivot view corresponding to a modified grid format.

FIG. 34A depicts a modified grid format after changes to axes/filters.

FIG. 34B depicts a pivot view corresponding to a modified grid format.

FIG. 35 is a block diagram illustrating the details of a digital processing system in which several aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure enables a user to specify a first pivot view as a publisher upon change of a criteria for selection of data points, and a second pivot view as a subscriber upon occurrence of the change. When an event representing a change of the criteria in the first view is detected, both the first view and the second view are updated reflecting the change in the selection criteria. In an embodiment, the change of criteria corresponds to a change in a filter common to both the views. Accordingly, a user may view the same or different set of data points according to respective axis of interest in the different views, and have the convenient view of changes to both the views as the filter is changed only in the first view.

According to another aspect of the present disclosure, the formation of elements of a pivot view is based on usage of GROUP BY and ROLLUP constructs. A first query containing a GROUP BY construct of all of the axis fields is executed on the base tables to identify rows with unique combinations of values. The columns of such identified rows are then examined to determine the set of relevant (detailed) axis values for that axis field (corresponding to the column in the base tables). A cell set is then defined with such axis values forming the (lower) column or (lower) row axis in the pivot grid. A second query contains a ROLLUP construct of all the row and column axis defined at the lowest level of hierarchy of the pivot grid, is executed on the base tables, in addition to the remaining axis fields of the view in a GROUP BY construct. Each position of the cell set is assigned one of the values from the output of the second query. The resulting data is displayed as a corresponding pivot view (grid or chart, in the disclosed embodiments).

According to yet another aspect, a user can modify the axis for a pivot chart, and an updated chart, corresponding to the modified axis, is displayed. In an embodiment, a user is provided the option of switching to grid view of the same data points on which the pivot chart is based. The column and row axis of the grid view are aligned with the X/Y-axes and filters of the pivot chart. The user is then permitted to manipulate (move, remove, slice/dice, etc.) the desired axes and filters of the pivot grid, and eventually switch back to the pivot chart view. The pivot chart view, including the changes caused by user manipulations, is thereafter immediately displayed.

The features described above can be implemented in combinations as well. For example, as the user manipulates the desired axes and filters of the pivot grid, the cell set and corresponding values can be formed using the GROUP BY and ROLLUP constructs, as described above.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

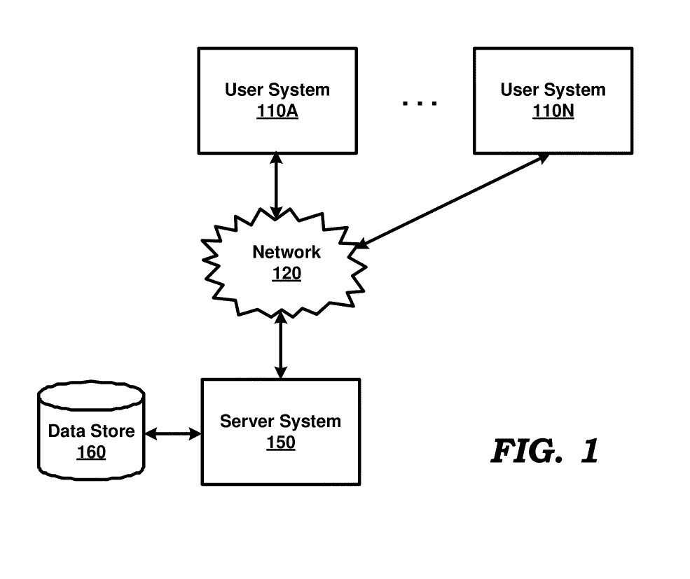

FIG. 1 is a block diagram illustrating an example environment (computing system) in which several aspects of the present disclosure can be implemented. The block diagram is shown containing user systems 110A-110N (collectively or individually referred to as 110, as will be clear from the context), network 120, server system 150 and data store 160. Merely for illustration, only representative number/type of systems is shown in FIG. 1. Many environments often contain many more systems, both in number and type, depending on the purpose for which the environment is designed. Each block of FIG. 1 is described below in further detail.

Network 120 provides connectivity between user systems 110A-110N and server system 150. Network 120 may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the target system to which the packet is to be eventually delivered. An IP packet is said to be directed to a target system when the destination IP address of the packet is set to the IP address of the target system, such that the packet is eventually delivered to the target system by network 120. Network 120 may be implemented using any combination of wire-based or wireless mediums.

Data store 160 represents a non-volatile (persistent) storage facilitating storage and retrieval of data by applications executing in server system 150. For purpose of illustration, it is assumed that data store 160 has available thereon various data generated, for example, due to the execution of such applications processing user requests. Data store 160 may be implemented as a corresponding database server using relational database technologies and accordingly provide storage and retrieval of data using structured queries such as SQL (Structured Query Language).

Each of user systems 110A-110N represents a system such as a personal computer, workstation, mobile station, mobile phones, computing tablets, etc., used by users to generate (user) requests directed to applications executing in server system 150. The user requests may be generated using appropriate user interfaces (for example, web pages provided by applications executing in server system 150). Aspects of the present disclosure facilitate users to view data stored in data store 160 in pivot views, as described in sections below.

Server system 150 represents a server, such as a web/application server, executing applications capable of processing (user) requests received from users using one of user systems 110A-110N. The server system 150 sends the result of processing of the user requests to the requesting user system 110A. Data generated by such processing may be stored (as base data/tables) in data store 160 and be displayed to users at user systems 110A-110N.

Server system 150 provides a convenient user interface enabling users to view the base data in the form of pivot views. It may be appreciated that the same base data can be viewed in different pivot views. Aspects of the present disclosure provide convenient user interfaces while interacting with such pivot views based on the same base data. Accordingly the description is continued with respect to such pivot views in an example scenario.

### 3. Multiple Pivot Views on Same Base Tables

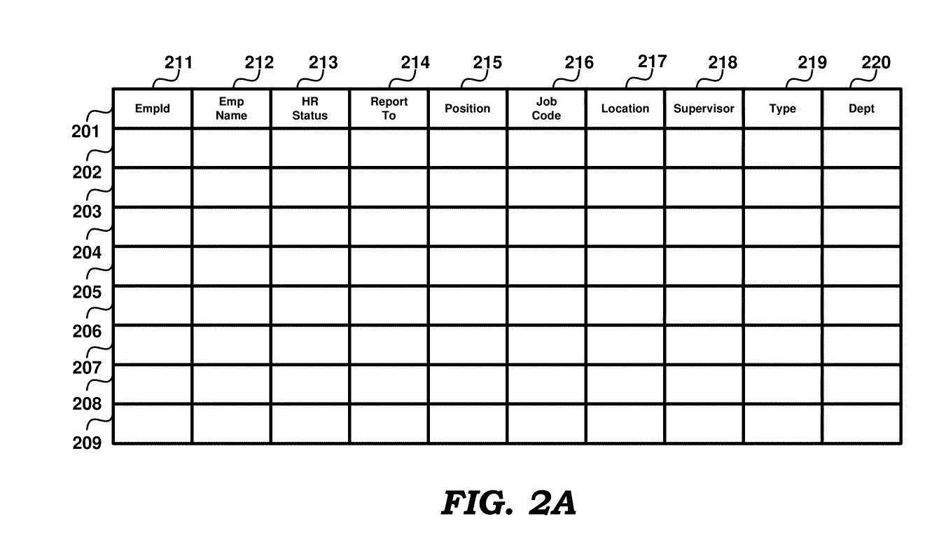

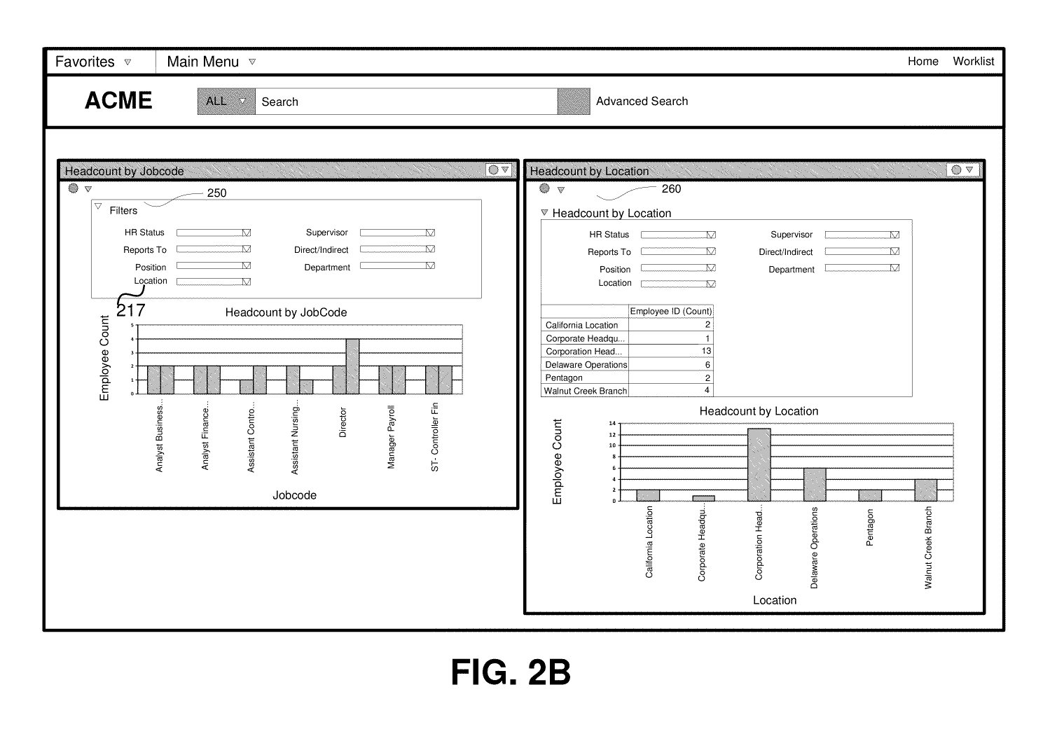

FIG. 2A depicts the schema/structure of an example (base) table. Table 200 is shown containing columns 211-220. The data there is not shown for conciseness. FIG. 2B contains two pivots views—one (250) based on jobCode and the second (260) based on location. First view 250 is shown containing a pivot chart, while second view 260 is shown containing both a pivot grid and a pivot chart. While first view 250 is shown with the data points categorized by Jobcode, second view 260 is shown with data points categorized by Location.

Each view is shown with corresponding filters. A filter operates to set criteria, which potentially excludes some of the data points of base table 200. For example, assuming that location is set to California location, the graphical display below is thereafter limited to employees having location 217 set to California (while excluding employees of other locations). In other words, the Employee Count would (potentially) be correspondingly reduced for each bar, compared to the no-filter display of FIG. 2B.

Both the views (portion 250 and 260 of FIG. 2B) are assumed to be based on the same data points (i.e., all the rows) of table 200 for simplicity (as would be the case when both the views are brought out first time), and accordingly the aggregate headcount in both the graphs is equal (28). However, alternative embodiments can be implemented in which different views are based on different base tables, but sharing at least one common filter (for definition of a selection criteria, as described below). Additional features of the user interface according to the present disclosure are described below.

### 4. Communication Between Pivot Views

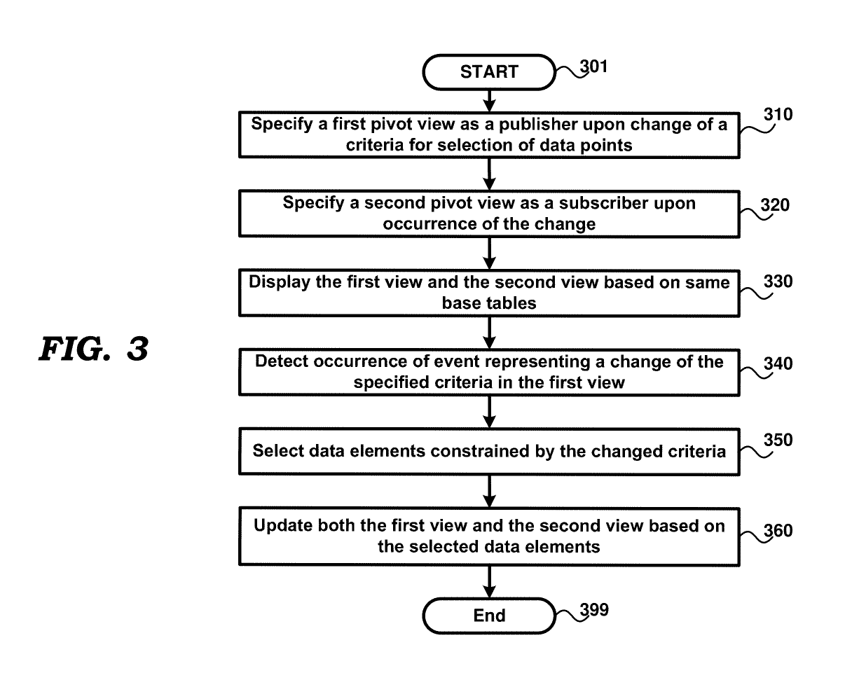

FIG. 3 is a flow chart illustrating the manner in which users may interact with pivot views according to an aspect of the present disclosure. The steps of the flowchart are described with respect to FIGS. 1 and 2 merely for illustration. However, the features can be implemented in other systems and environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 301, in which control immediately passes to step 310.

In step 310, server system 150 enables a user to specify a first pivot view as a publisher upon change of a criteria for selection of data points. For example, with respect to FIG. 2B, the first pivot view (based on JobCode 216) may be specified to be the publisher upon a user specifying a criteria based on the Supervisor field (e.g., to set to one or more employees operating as supervisors using Supervisor filter of FIG. 2B).

In step 320, server system 150 enables a user to specify a second view(260) as a subscriber upon occurrence of the change. The specification of a publisher-subscriber combination associated with an event (i.e., change in criteria based on the supervisor field) implies that a change occurring with respect to the publisher is propagated to the subscriber as well. The second view of FIG. 2B (based on location 217) may be specified to be the subscriber for notification of the change specified in step 310.

In step 330, server system 150 causes display of the first view(250) and the second view(260) based on same base tables and the corresponding data points of the tables. Both the views may be sent for display on a same page as depicted in FIG. 2B. The tables of FIG. 2A may be queries to retrieve the applicable data points, and the bar graph (pivot chart) of FIG. 2B may be displayed based on the retrieved data points.

In step 340, server system 150 detects the occurrence of an event representing a change of the specified criteria in the first view(250). The criteria may be specified, for example, based on one of the filters shown in area 250, as also noted above. In the illustrative example, the event represents specification of some value for the Supervisor field by a user while interacting with the first pivot view of FIG. 2B.

In step 350, server system 150 selects data elements constrained by the changed criteria. In other words, compared to in FIG. 2B, some of the data points may be excluded from consideration, in view of the specification of the filter. Data store 160 may be queried to select the data elements. The manner in which the queries may be generated is described with additional examples in sections below.

In step 360, server system 150 updates both the first view(250) and the second view(260) based on the selected data elements. In other words, the changes specified associated with a publisher are propagated to the corresponding subscribers. The flow chart ends in step 399.

While the flowchart is described as being performed by server system 150, it may be appreciated that some or all of the steps may be performed in user system 110 in alternative embodiments. For example, server system 150 may send a web page containing appropriate scripts (or programming logic), which causes such steps to be performed at user system 110.

The description is continued with respect to example user interfaces using which the above features can be implemented.

### 5. User Interface

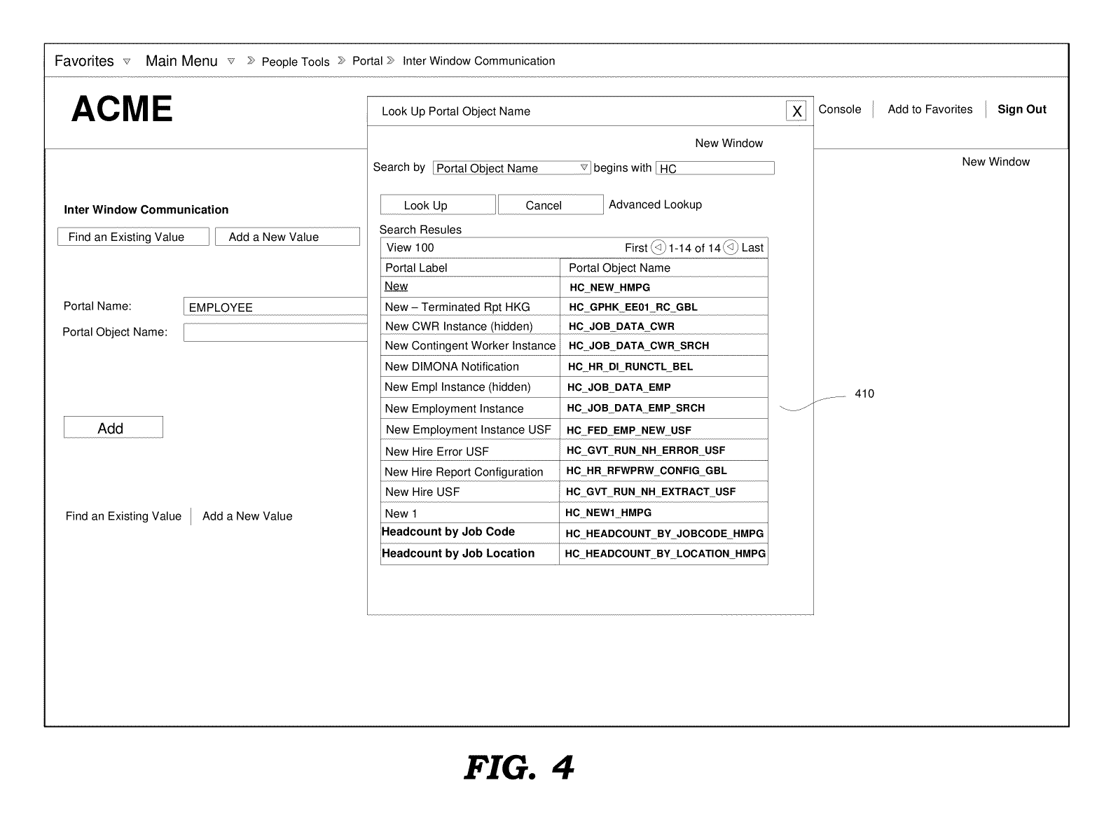

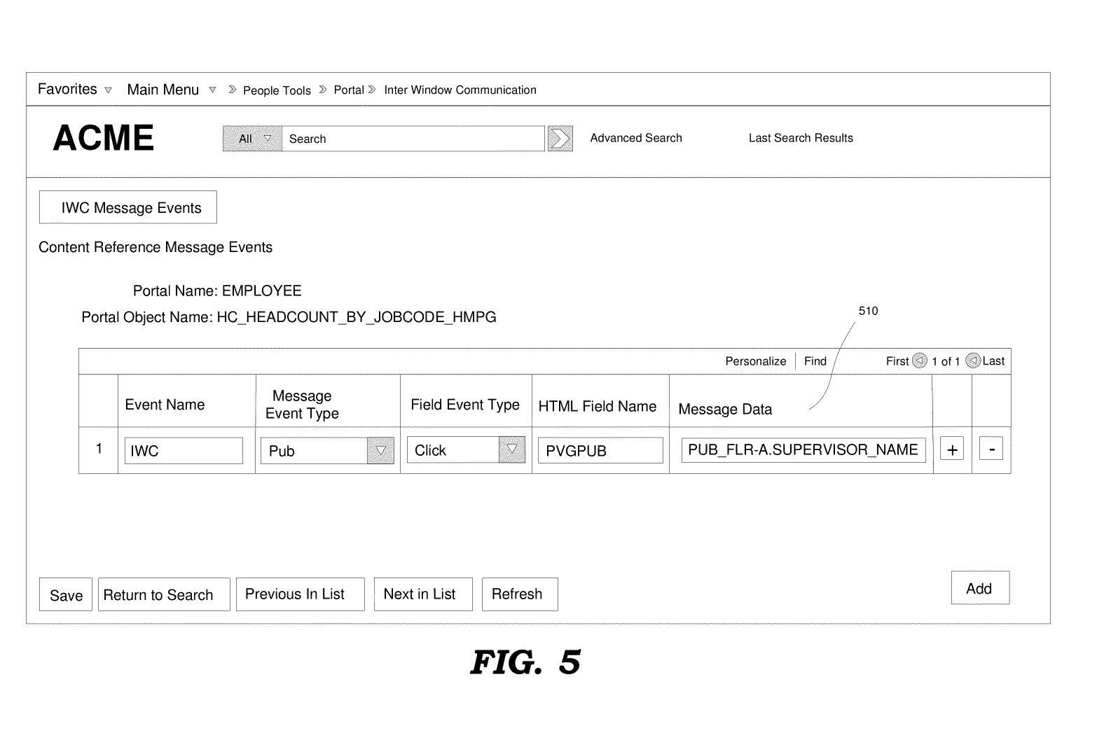

FIGS. 4 and 5 illustrate the manner in which an administrator can specify a pivot view as a publisher upon change of criteria for selection of data points. In particular, FIG. 4 depicts a display screen displaying the pivot views that are pre-defined. The administrator can select one of the displayed views (in the list of options 410) as a publisher. The administrator is assumed to have selected a pivot view entitled, “Headcount by Job Code”, and consequently the user interface of FIG. 5 is generated.

FIG. 5 depicts a display screen displayed upon the administrator having selected a pivot view. Event name is used to uniquely identify an event (and is user configured while defining the event in accordance with FIG. 5), which can be later subscribed to, by various subscribers. Message event type indicates that the occurrence is to cause publication. Field Event Type (click) and HTML Field name (pivot grid publication) are for facilitating features unrelated to the present disclosure, and is not described herein for conciseness.

Message data field 510 represents a selection of the appropriate filter (e.g., using a drop-down list permitting selection of multiple items in the list), on which the event is sought to be triggered Multiple filters can be selected in the screen of FIG. 5. It may be appreciated that the label/text in field 510 is according to a convention in which the last part represents the specific filter field name (here, SUPERVISOR_NAME), which is the basis for the event. Upon saving of the values thus specified for various fields of the screen, the published events are available for subscription at/by various other pivot views.

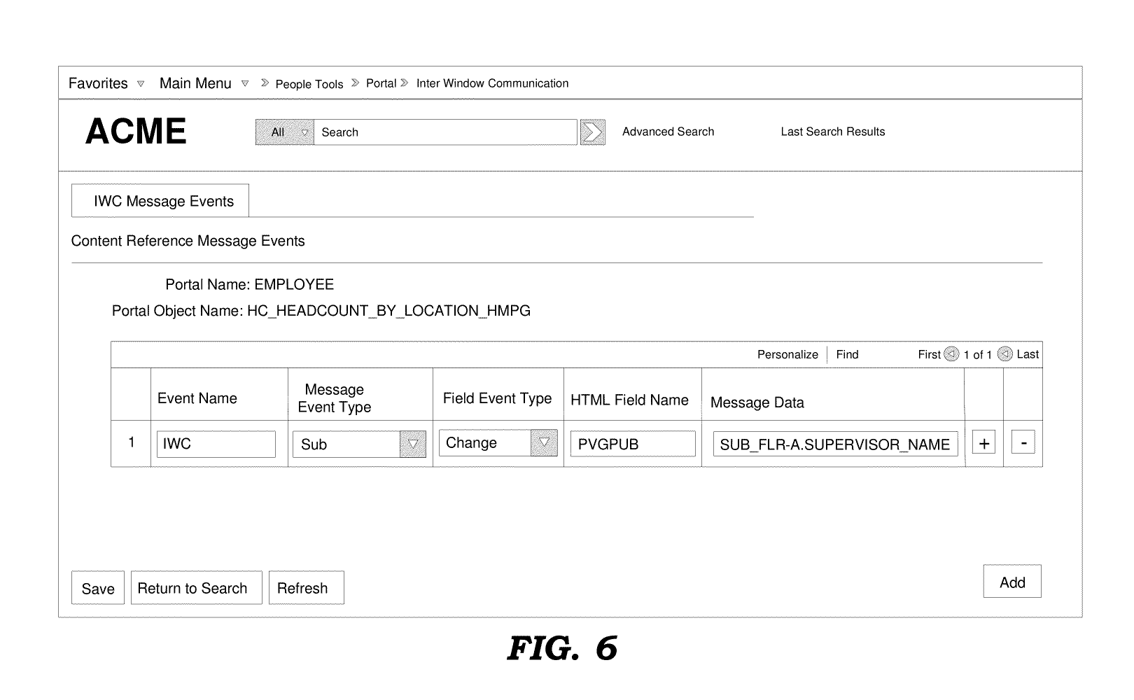

FIG. 6 illustrates the manner in which a administrator can specify a pivot view as a subscriber. It is assumed that the administrator has selected HC_HEADCOUNT_BY_LOCATION_HMPG (corresponding to the second pivot view(260) of FIG. 2B), and the user interface of FIG. 6 is provided as a result. The administrator is shown subscribing to the same event ‘IWC’ defined in FIG. 5 by specifying the Event Name as IWC and Message event type as ‘Sub’. The subscription is shown specified as being upon a change of criteria by setting Field Event Type to Change (implying when there is a change of filter value). The Message Data is shown being automatically (i.e., by operation of the software, without specific user intervention for this purpose) populated with the appropriate filter field name (but with SUB for subscription, instead of PUB for publisher, compared to in FIG. 5) in view of the event IWC being triggered. Once administrators configure the publisher/subscriber relationships, users can conveniently use the corresponding user interfaces as described below.

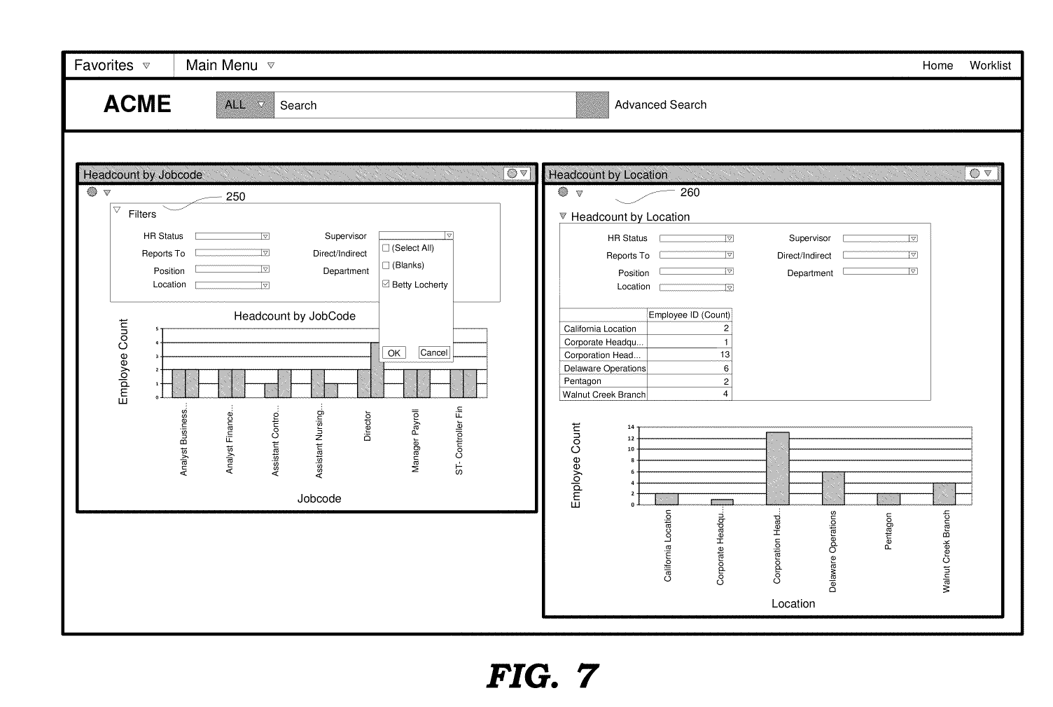

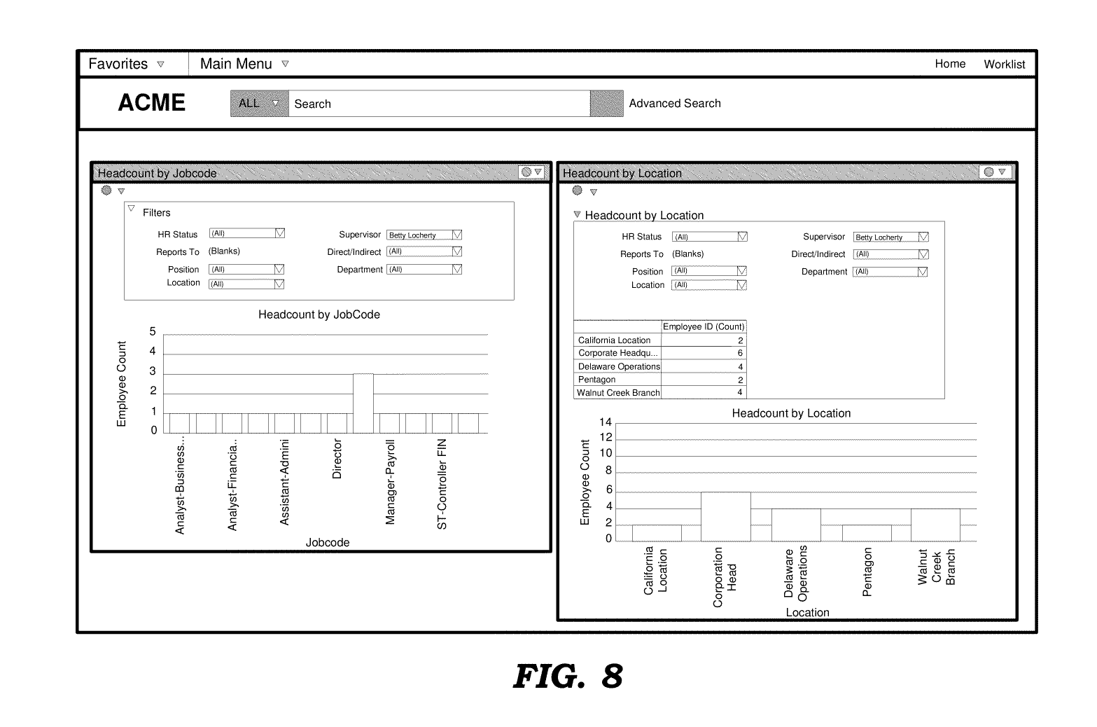

FIG. 7 depicts a user selecting a specific value for Supervisor filter in first view configured as publisher. FIG. 8 depicts the first view updated with the specified filter applied. The second view (to the right) is shown with the same filter propagated automatically (i.e., without requiring specific further user inputs). That is, all the data elements forming the basis for the display of FIG. 7 (in both views 250 and 260) have supervisor equaling the specified value (i.e., Betty Locherty)

It may thus be appreciated that the user has enhanced convenience of selectively being able to automatically propagate changes in filters in one view to another view. In other words, in the absence of the specification similar to FIGS. 4-6 (with respect to some other pivot view), a change in filter similar to in FIG. 7 would not propagate the changes to the second view.

The description is continued with respect to the details of server system 150 in an embodiment.

### 6. Server System

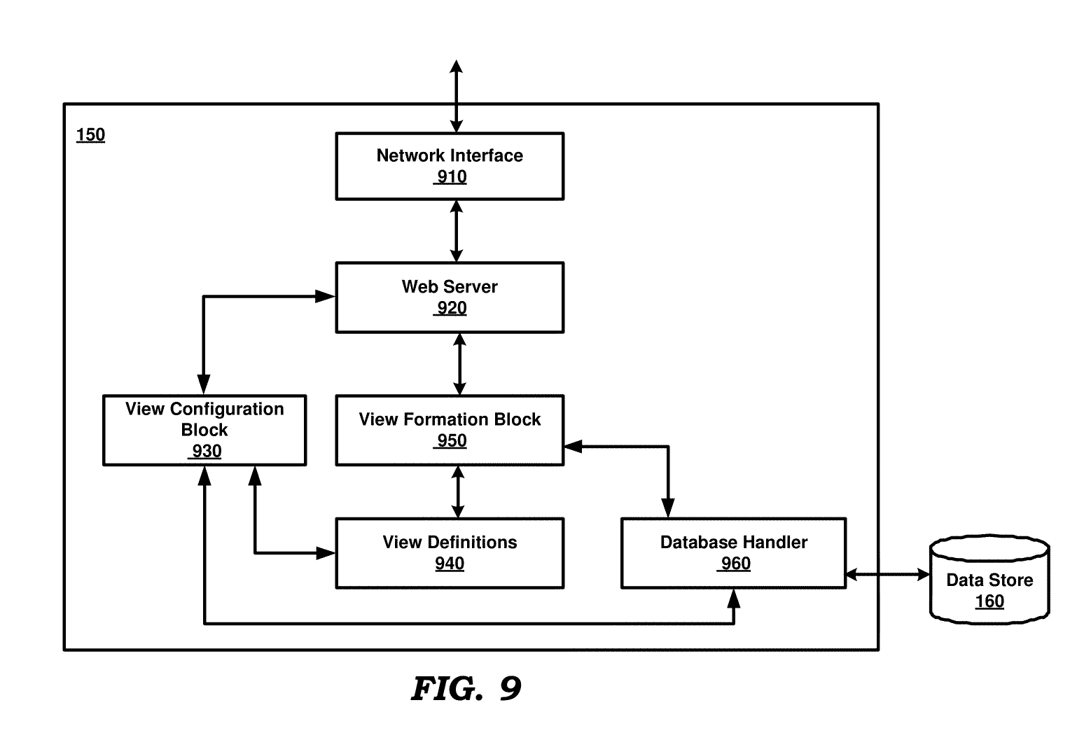

FIG. 9 is a block diagram illustrating the details of server system 150 in an embodiment. Server System 150 is shown containing network interface 910, web server 920, view configuration block 930, view definition 940, view formation block 950, and database handler 960. Each block is described below in further detail.

Network interface 910 provides electrical and protocol interfaces (e.g., network cards, network protocol stacks, etc.) to enable various blocks of server system 150 to communicate via network 120. In general, packets directed to server system 150 are examined for forwarding to the appropriate internal block/application. Similarly, network interface 910 sends packets directed to other external systems (upon receipt of the corresponding packets from the respective internal blocks of FIG. 9). Network interface 910 may be implemented in a known way.

Web server 920 provides a convenient front end interface using which users may interact with server system 150. Web server 920 receives requests from client system 110 and depending on the request, it propagates it further to one of the blocks of server system 150. Web server 920 may be implemented based on various web server products such as Oracle WebLogic, IBM WebSphere etc. servers, available in the marketplace. In an embodiment, web server 920 provides the interface by serving HTML web pages to user systems 110A-110N.

View configuration block 930 facilitates users to define/configure pivot views, in addition to the subscriber-publisher relationships (for example, using the interfaces described above). Definition of a pivot view entails specifying rows, columns and filters for the view. The user can also specify a base query/table on which pivot view is to be defined. The configured information is stored in view definition 940 (for operation), and also in data store 160. View definition 940 represents a buffer where pivot view definitions created using View configuration block 930 and the configured publisher-subscriber information, are stored temporarily.

Database handler block 960 provides interfaces, which are invocable by various blocks to store/retrieve data. Such storing/retrieval may be based on various SQL queries. As noted above, the data forming for pivot views, as well as configuration data defining the structure of pivot views (and the configured publisher-subscriber information) can be stored in data store 160.

View formation block 950 generates (or sends for display) a pivot view as per configurations (view definition) specified by a user and the corresponding base data/tables stored in data store 160. Multiple pivot views (potentially based on different base tables) may be sent for display, depending on user requests. In addition, when an indication of a change of filter is received for a pivot view, view formation block 950 may generate a fresh query to retrieve the corresponding data from data store 160, and refresh the pivot view to correspond to the newly retrieved data.

In addition, if such refreshed pivot view is shown to be configured as a publisher in relation to the specific field forming the basis for the changed filter, view formation block 950 identifies any pivot views configured as subscribers for the same field/filter. In the illustrative example of FIGS. 5-8 above, the second view (headcount by location) is identified as a subscriber when a change is made to Supervisor filter of the first view (headcount by job code). View formation block 950 accordingly issues any needed queries to retrieve data constrained by the same change (to the Supervisor filter) for the second view. The second view is accordingly automatically refreshed with the updated data.

In an embodiment, view formation block 950 notifies the subscriber (view 260) of the change (“publisher change”) sought by the publisher (here, Supervisor being set to a specific value in view 250). In response, view 260 sends a change request indicating the same change to its view, in addition to information on existing constraints. The existing constraints may include those filter values (“prior filter values”) that have been set in view 260 as of that time instance (e.g., department being set to some value causing data points to be reduced by that time instance already). Accordingly, view formation block 950 may issue a query with the combined constraints of the prior filter values and the publisher change. View 260 is updated based on the results of the query.

It may accordingly be appreciated that data points underlying views 250 and 260 can be different, though initially both may be instantiated with the same data points. For example, when the two views are instantiated, 200 of the 350 data points in the base table may be the basis for display of the two views. Thereafter, a user may set a filter in view 260 to cause the display to represent only 160 of the 200 data points. Assuming, the user sets the Supervisor filter in view 250 (publisher) to cause the corresponding display to be generated based on 180 data points, it may be appreciated that the Supervisor filter is further applied only on the 160 data points of view 260 to update the display there.

However, a simpler case is when both the views represent the same (e.g., 200 noted above) data points. In such a case also, the user can have different axes for the two views, and as filter is applied in one view, the effect in the second view is also conveniently observed for the same data points. While the features are described with respect to two views for conciseness, it may be appreciated that many subscribers (of corresponding views) may be configured, and the user may be able to view the changes effected in all such configured subscribers.

It may be appreciated that view formation block 950 generates SQL queries to data store 160, assuming data store 160 represents a relational database. Aspects of the present disclosure provide for efficient formation of pivot views (by view formation block 950) based on ‘Rollup’, ‘group by’ and ‘grouping’ SQL constructs. The constructs are briefly described below first.

### 7. Rollup, Group By and Grouping in SQL

A brief introduction of the three constructs is provided below. However, for further details of ROLLUP AND GROUP BY and other aspects of the present disclosure, the reader is referred to a documents entitled “Oracle® Database Data Warehousing Guide—11g Release 1 (11.1)” Number: B28313-02 from Oracle Corporation, available at the below URL:

http://docs.oracle.com/cd/B28359_{—}01/server.111/b28313/aggreg.htm#autoId0

For further details of GROUPING construct and other aspects of the present disclosure, the reader is referred to a documents entitled “Oracle® Database SQL Language Reference 11g Release 1 (11.1)”, Number: B28286-06 from Oracle Corporation, available at the below URL:

GROUPING—http://docs.oracle.com/cd/B28359_{—}01/server.111/b28286/functions064.htm

A Group By construct of a SQL query has the form.

group by Column-name1, Column-name2 . . .

In operation, assuming there are N columns specified in the group-by construct, the construct returns as many of the unique combination of N-tuples as are present in the base tables to which the query is applied. In a simple case of only one column being specified, the construct returns unique list of values in that column. In case two columns are specified, the construct returns unique pairs present in the underlying table, with first element belonging to the first column and the second element belonging to the second column.

A rollup construct takes an ordered list of (M) columns as parameters, and operates to return several (M+1) tuples, with the first M-elements corresponding to the M-columns, and the last element providing a sub-total for the corresponding M-element combination. The number of tuples returned may be viewed as being (M+1) levels, with each level having several tuples. In the first level, all unique combination of values present in M columns (and the respective totals) are included. In the second level, only the right most (last) column is set to ‘ALL’ (don't care) and (M−1) left most columns having unique values are included as respective tuples (with the aggregate value in the last column).

For each subsequent level, another column from the right is set to ‘ALL’, while including tuples with unique combination of values for the rest of the columns. The last (i.e., (M+1)st) level would include ‘ALL’ for all the M columns, to obtain a grand total for all applicable rows in the M-columns.

To understand the GROUPING construct, it should be appreciated that the ‘ALL’ may be represented by NULL, while there may be stored values which are also NULL. The GROUPING construct takes a column as a parameter, and indicates whether a value for that column represents ALL (say by 1) or it is a stored NULL value (say by 0).

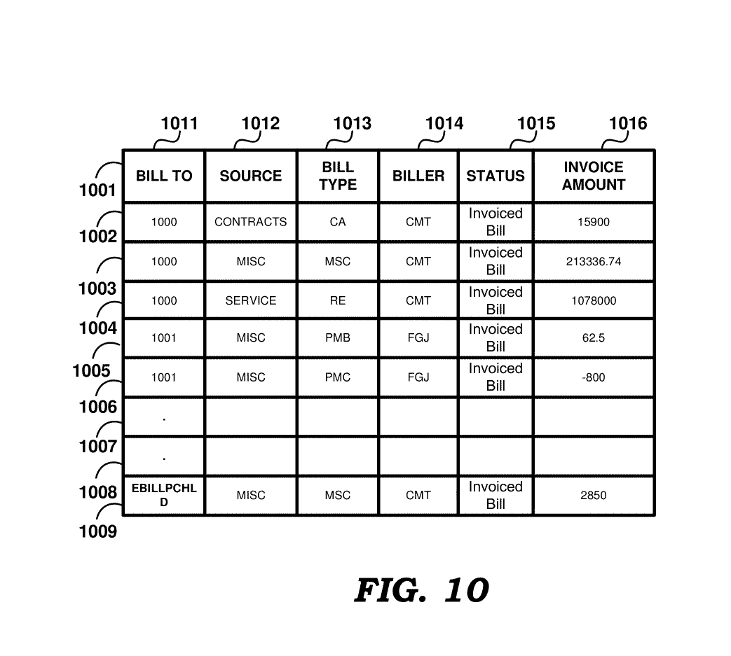

The manner in which the above constructs are used to generate pivot views according to various aspects of the present disclosure, is described below with examples. For illustration, the table of FIG. 10 is shown containing columns 1011-1016 (with the column names noted in row 1001) and the data being shown in rows 1002-1009. Only representative rows are shown, as depicted by blank rows in 1006-1007 (representing several other actual rows that would be present in the base table there). The entire base table is included in Appendix attached hereto.

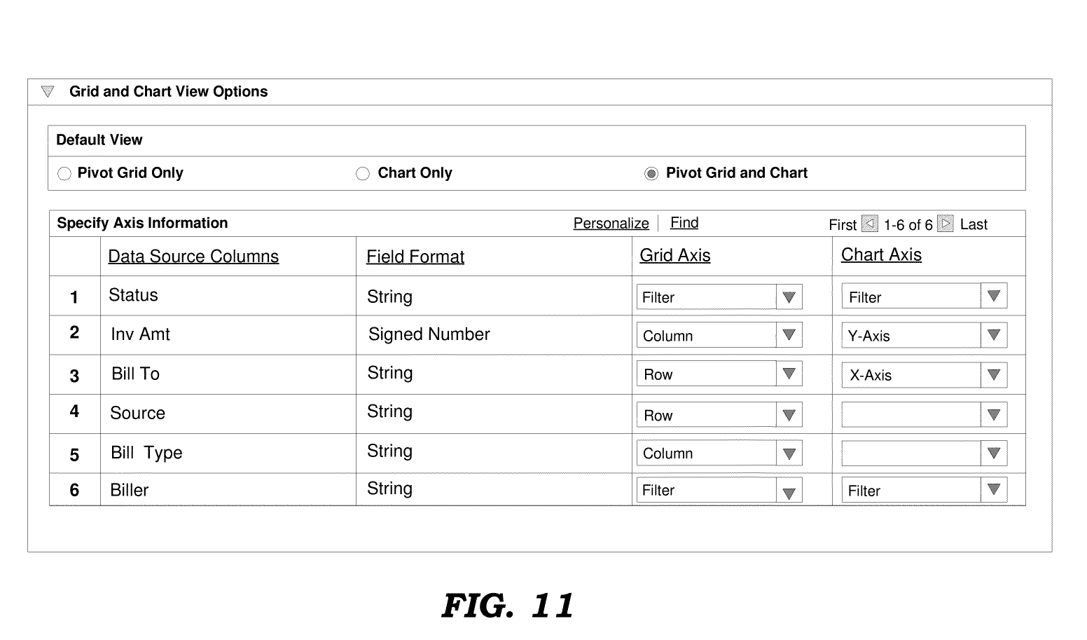

FIG. 11 depicts the schema for a pivot view for the base table of FIG. 10. It is assumed that the pivot view is previously defined to be for aggregate value on ‘Invoice Amount’ field, though not shown. As relevant to the pivot view, the ‘Invoice Amount’ is termed as a ‘value field’, while the remaining columns of the base table on which the dimensions of the pivot view is plotted, are termed as the ‘axis fields’. In case of pivot charts displayed in two dimension, each axis/value field is configured to be along either X or Y. In case of grid views displayed in two dimensions, each axis/value field is specified as row axis or column axis. In addition, some of the table columns can be specified as filters, as shown.

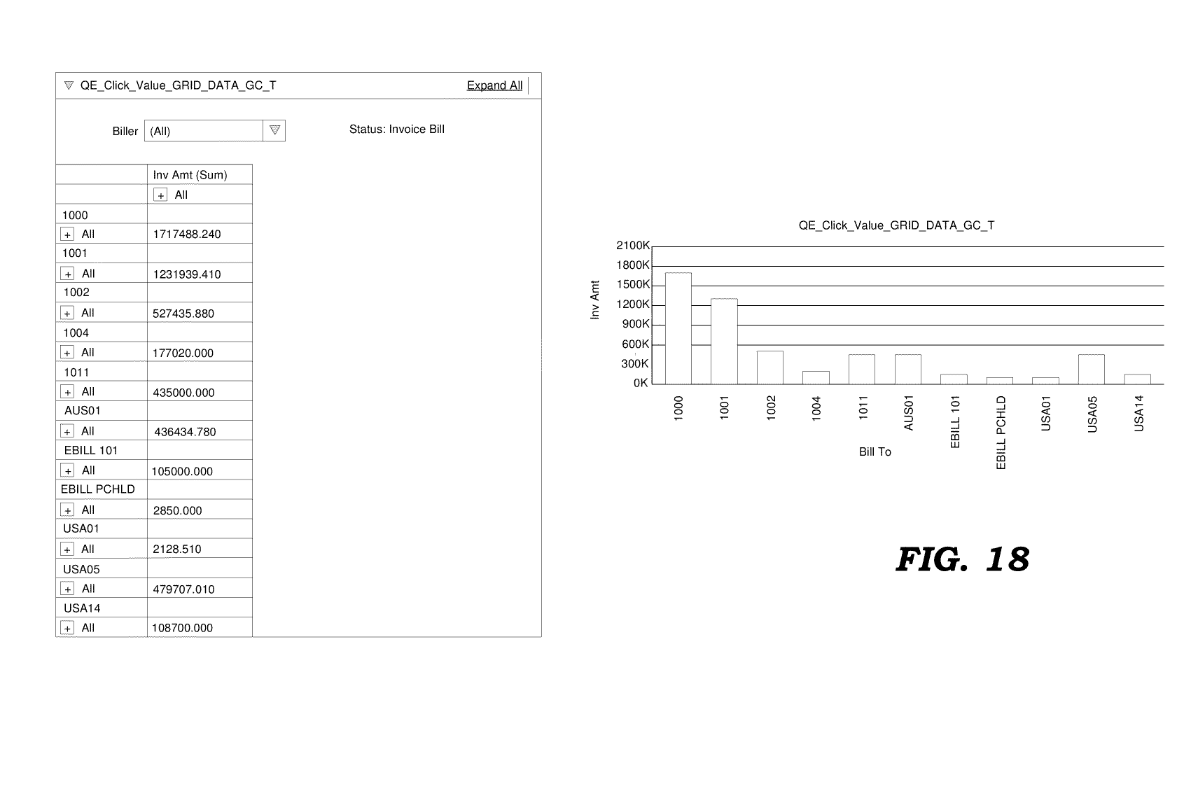

The pivot view is shown having grid and chart views, and different configurations being provided for both. For the Grid, the user is shown as having specified Status and Biller as filters, Bill type and invoice amount as Column Axis, and Bill To and Source as row axis. For the chart, Bill To is the X-axis and Inv Amount is the Y-axis. The eventual pivot view is shown in FIG. 18. The manner in which the pivot view data is formed and displayed, is described below.

### 8. Generating Pivot View

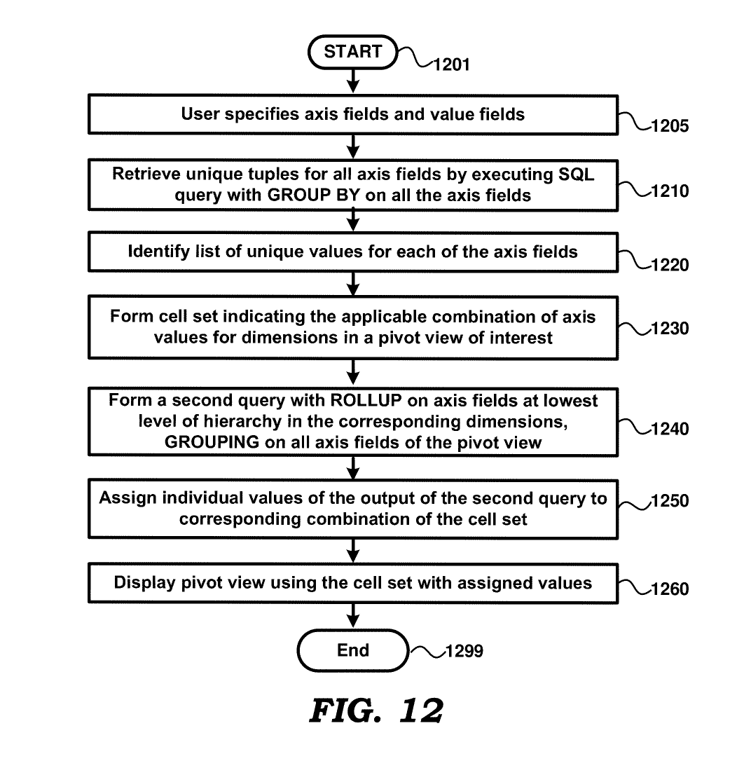

FIG. 12 is a flow chart illustrating the manner in which pivot view is formed using two database queries. The flowchart is described with respect to the systems of FIG. 1 and the examples herein, merely for illustration. However, the features can be implemented in other systems and environments also without departing from the scope and spirit of various aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 1201, in which control immediately passes to step 1205.

In step 1205, a user specifies a corresponding set of axis fields and value fields, for each a pivot view of interest. When multiple axes are specified in a dimension (i.e., column or row for grid view, and X or Y axis for chart view), such multiple axes are viewed as being in a hierarchy, with one axis at the highest level and the remaining at lower levels.

In step 1210, view formation block 950 retrieves unique tuples for all axis fields by executing SQL query with GROUP BY on all the table columns corresponding to the axis fields. Thus, a mapping of each column of the table to the corresponding axis field may also be maintained within view definition 940, and view formation block 950 accordingly examines the corresponding data to first determine the specific column identifiers to be included in the SQL query.

In step 1220, view formation block 950 identifies a list of unique values (axis values) for each of the table columns (or corresponding axis fields) in the tuples retrieved in step 1210. As may be appreciated, these values are eventually used as axis values, for which corresponding detailed facts are displayed. It may be appreciated that multiple tuples of step 1210 may have the same value for an axis, and thus the duplicates are removed in forming the list for each axis. Such a feature is particularly important when the base tables can have a large number (e.g., of the order of millions) of records, and the GROUPBY operates to conveniently provide only a smaller subset of unique records, thereby reducing the number of records retrieved and processed in a random access memory (RAM).

In step 1230, view formation block 950 forms a cell set indicating the applicable combination of axis values for dimensions in a pivot view of interest. As may be appreciated, the number of combinations of interest would depend on the extent of detail indicated as being of interest, as illustrated with examples below. Some of the combination of values would not be of interest, assuming the user has chosen to not expand to the lowest level of detail in the pivot view.

In step 1240, view formation block 950 forms a second query with ROLLUP on axis fields at the lowest level of hierarchy in the corresponding dimensions, and GROUPING on all axis fields of the pivot view. The second query in addition specifies that the aggregation of the values (specified by the value field) is by the fact of interest. The output generated may be viewed as a table containing all possible aggregate values of interest.

In step 1250, view formation block 950 assigns individual values of the output of the second query to corresponding combination of the cell set. As the cell set indicates only the applicable facts of interest, the corresponding values may be selected from the output of the second query. In step 1260, view formation block 950 sends the pivot view thus formed, for display. The flow chart ends in step 1299 thereafter.

Though not expressly described with respect to FIG. 12, it should be appreciated that the user may also specify filters for the corresponding pivot view. In such a case, the second query may be modified to account for the filters, for example, as a ‘where’ clause to constrain the data points considered for the view.

Thus, in accordance with the approach of FIG. 12, only two queries are executed on the relational tables of data store 160 to generate each pivot view. It should be appreciated that the cell set changes as a user requests less/more detail, and steps 1230-1260 are executed upon each change/request.

In addition, when a filter is added/removed, the corresponding condition is added to both the queries to constrain the data points applicable in the display of the pivot view. The features of the flowchart in some example implementations, are illustrated below.

### 9. Examples

From the above, it may be appreciated that two queries are generated for each pivot view. The queries respectively operate to retrieve:
1. The list of distinct/unique values for each axis field which should be plotted on the pivot view
2. The actual aggregated value for each data point

Assuming FIG. 11 represents the schema of the pivot view, and that FIG. 10 represents the base table (TABLENAME), the first query constructed in step 1210 is shown below:

### SELECT BILL TO, SOURCE, BILL TYPE, STATUS, BILLER, COUNT(*)

### FROM TABLENAME

### GROUP BY BILL TO, SOURCE, BILL TYPE, STATUS, BILLER;

As may be appreciated, view formation block 950 includes all the axis fields in the GROUP BY clause (as well as select clause). All the axis fields are selected for further processing by view formation block 950.

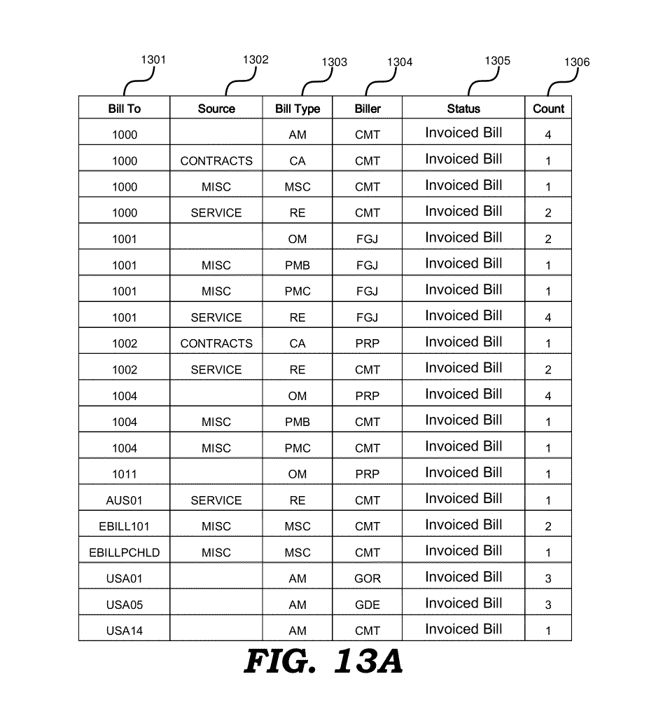

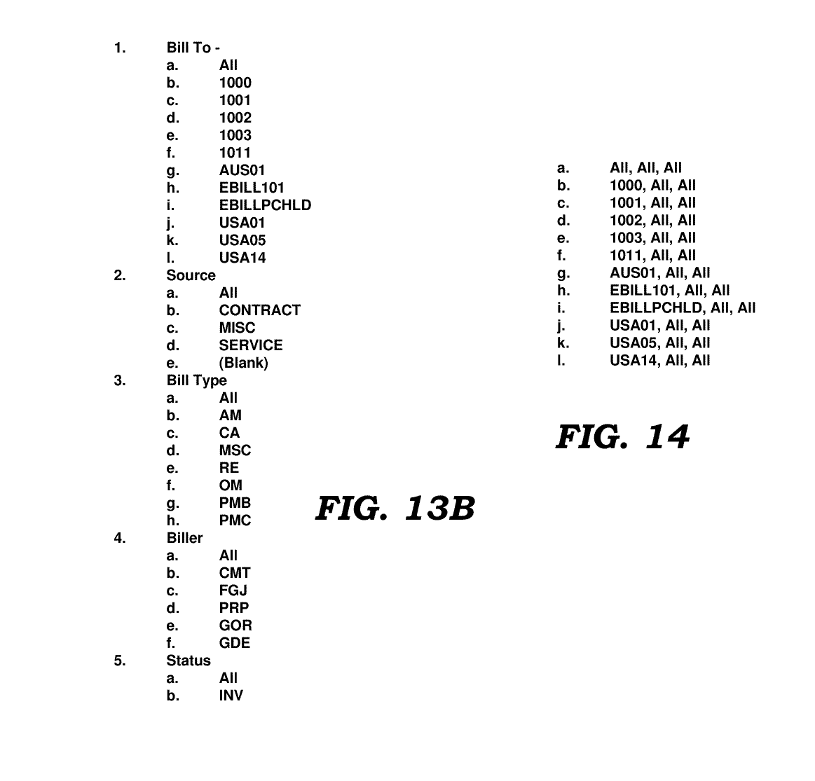

FIG. 13A depicts the output of the first query. The count for each tuple is shown in the last column there. This output of this first query is parsed and the unique individual values of each of the axes fields are retrieved.

FIG. 13B contains the respective list of unique values for each of the axis fields (step 1220). The unique/distinct values in each of the columns of FIG. 13A may be determined programmatically in a known way. As may be appreciated, these values represent the potential elements displayed for row/column axes at corresponding level of detail (if the user requests such level of detail while interacting with the pivot view), and are thus termed as axis values.

As noted above, steps 1230 onwards are performed to correspond to each level of detail that a user may select while interacting with the pivot view. The steps are illustrated for a few use cases below.

### 10. Use Case 1: Initial Rendering of Pivot View

For use case 1, it is assumed that there is no expansion on row or columns FIG. 14 depicts cell set generated for this use case (step 1230) by view formation block 950. First column (or value in the three values of each line) of cell set corresponds to ‘Bill To’, second column corresponds to ‘Source’ and third column corresponds to ‘Bill Type’. As there are no expansion on row and column, second and third column of cell set is shown having only ‘All’ value.

The second query to retrieve the actual data (step 1240) is formed as:

### SELECT BILL TO, SOURCE, BILL TYPE, SUM (INVOICE AMOUNT),

### GROUPING(BILL TO) AS DIM1M,

### GROUPING(SOURCE) AS DIM2M,

### GROUPING(BILL TYPE) AS DIM3M

### FROM TABLENAME

### GROUP BY BILL TO, ROLLUP(SOURCE), ROLLUP(BILL TYPE);

As may be appreciated, the select clause contains the fact of interest (i.e., invoice amount), in addition to the three relevant axis fields. The GROUP BY clause also contains the three axis fields, except that ROLLUP is performed on the axis fields in the lowest level of hierarchy in each dimension (i.e., SOURCE in X/row, and BILL TYPE in Y/column). Implementation of filters typically entails additional clauses (where SQL clause), but are not shown for conciseness.

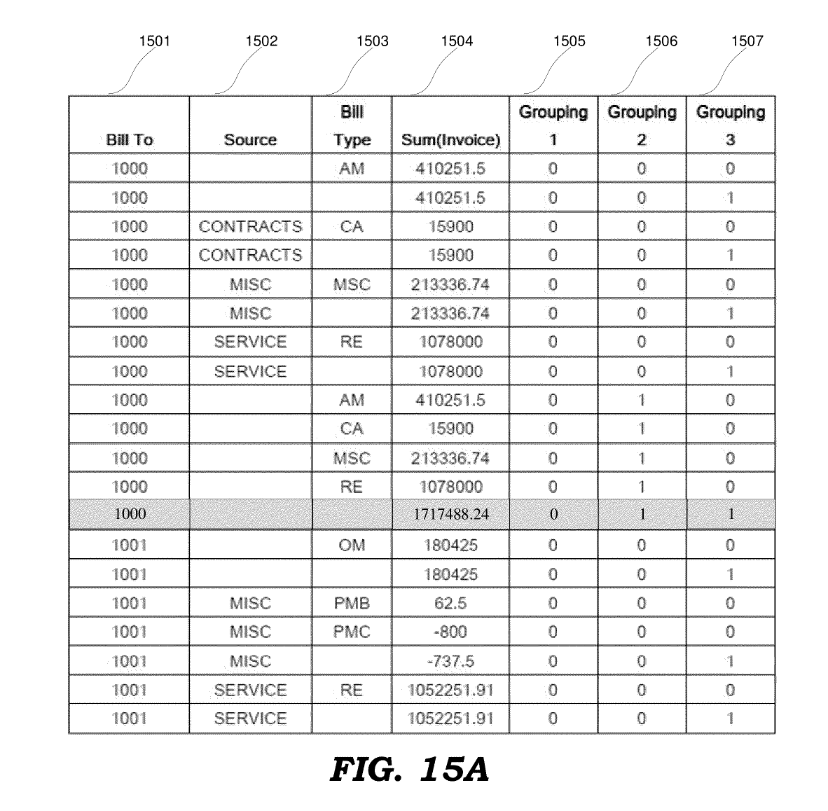

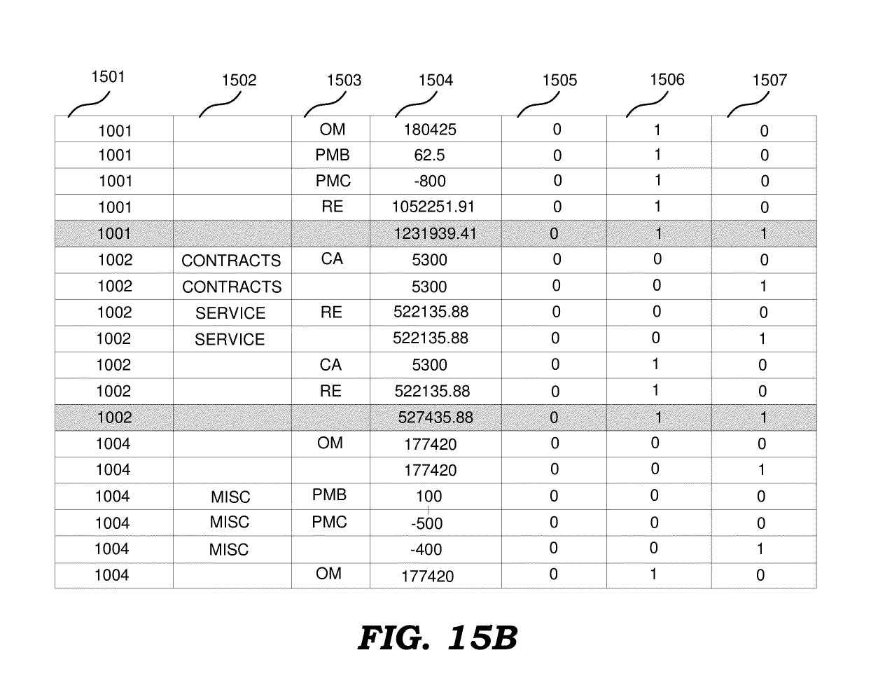

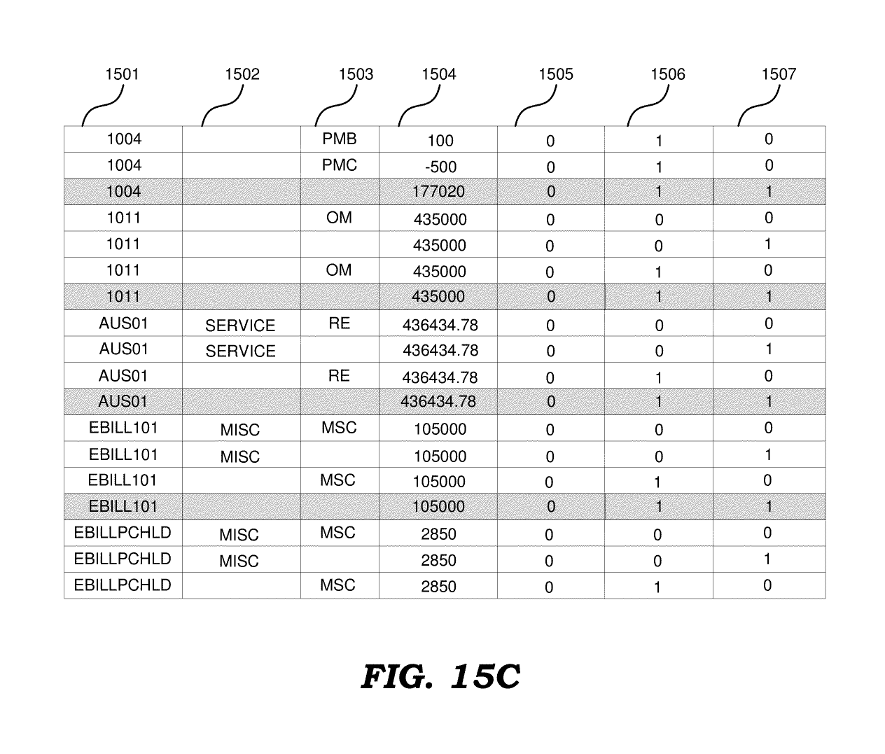

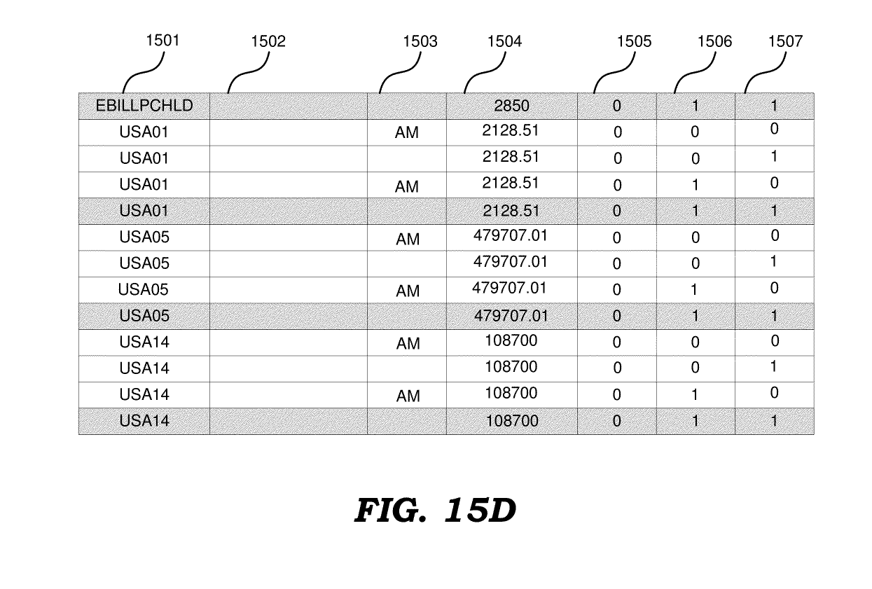

FIGS. 15A-15D together depict the output of the second query (i.e., data elements retrieved by execution of the query). It may be readily observed that the four figures together represent one output, though shown separated as four figures merely in view of the number of rows. The table is shown containing sub-totals at multiple levels, for all potential combinations in the base tables.

The table may be viewed as having three axis columns (1501-1503), a sum column (1504), and three grouping columns (1505-1507). Each grouping column corresponds to a corresponding axis column of the three axis columns. A value of 1 in the Grouping columns indicates that all or any value for the corresponding axis element is deemed to contribute to the Sum of the corresponding row. In other words, multiple rows from the base table would be considered with different values for the Axis (having 1 for grouping). On the other hand, a value of 0 in the Grouping column indicates that the corresponding value in the Axis column is specific. In such a case, only those rows from the base table having that specific value for the Axis column would contribute to the Sum value.

A blank value for an Axis Column may either correspond to a value of 1 in the corresponding Grouping Column, or the Axis column may itself have a blank value (in combination with a value of 0 in the corresponding Column).

| | | Bill | Sum | Grouping | Grouping | Group- |
|---|---|---|---|---|---|---|
| Bill To | Source | Type | (Invoice) | 1 | 2 | ing 3 |
| 1000 | | AM | 410251.5 | 0 | 0 | 0 |
| 1000 | | | 410251.5 | 0 | 0 | 1 |
| 1000 | | | 1717488.24 | 0 | 1 | 1 |

For example, in the three rows extracted from the table of FIG. 15A, the first row above indicates that all Axis values are specific values, even though the Source is shown with a blank value.

The second row above indicates, Bill To and Source axis values are specific and Bill Type is ALL/don't care values. In other words, the sum there represents the additive effect of records matching the specific values of Bill To and Source, irrespective of Bill Type value.

The third row indicates that the Sum there is an aggregate value of invoice amount, when Bill To has a specific value equaling 1000.

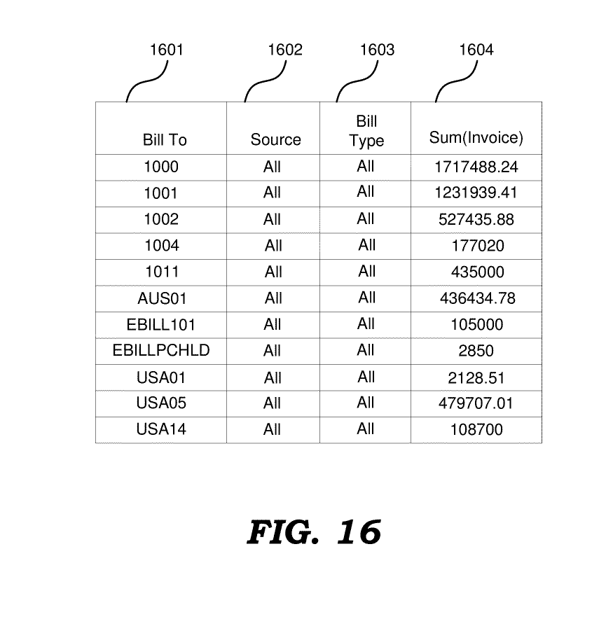

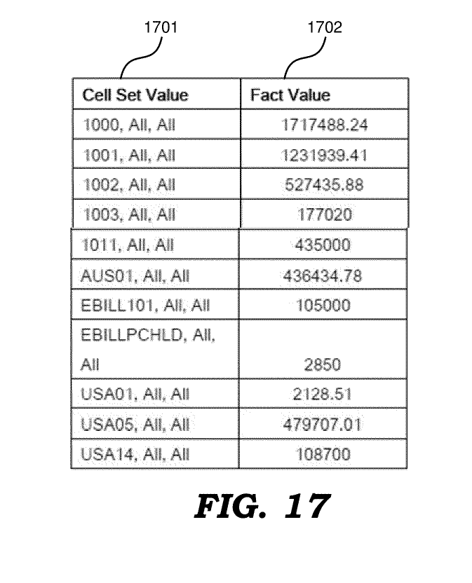

FIG. 16 depicts the relevant extracted values from the table of FIGS. 15A-15D. The relevant extracted values depend on the level of detail at which the pivot view is being viewed/operated at. In the default view shown in FIG. 18 below, only the third row above would be extracted, because the invoice sum of the remaining two rows are not required for that view. In general, all rows having the Grouping 2 1506 and grouping 3 1507 as 1, are selected for cell set formation, in the default view.

FIG. 17 depicts a temporary table with each extracted relevant value of FIG. 16 assigned to the corresponding combination/entry of the cell set. FIG. 18 shows the corresponding pivot view display. The implementation of view formation block 950 in accordance with FIGS. 17 and 18 will be apparent to one skilled in the relevant arts, by reading the disclosure provided herein.

### 11. Use Case 2: Expansion of Row and/or Column

For use case 2, it is assumed that the user expands one or more rows and/or columns, in particular, row 1801 of the table of FIG. 18, corresponding to “1002” for “Bill To” and it also expands Bill Type column. In these cases, both the first and second query to retrieve data remains the same. However, the cell set values change, reflecting the additional detail.

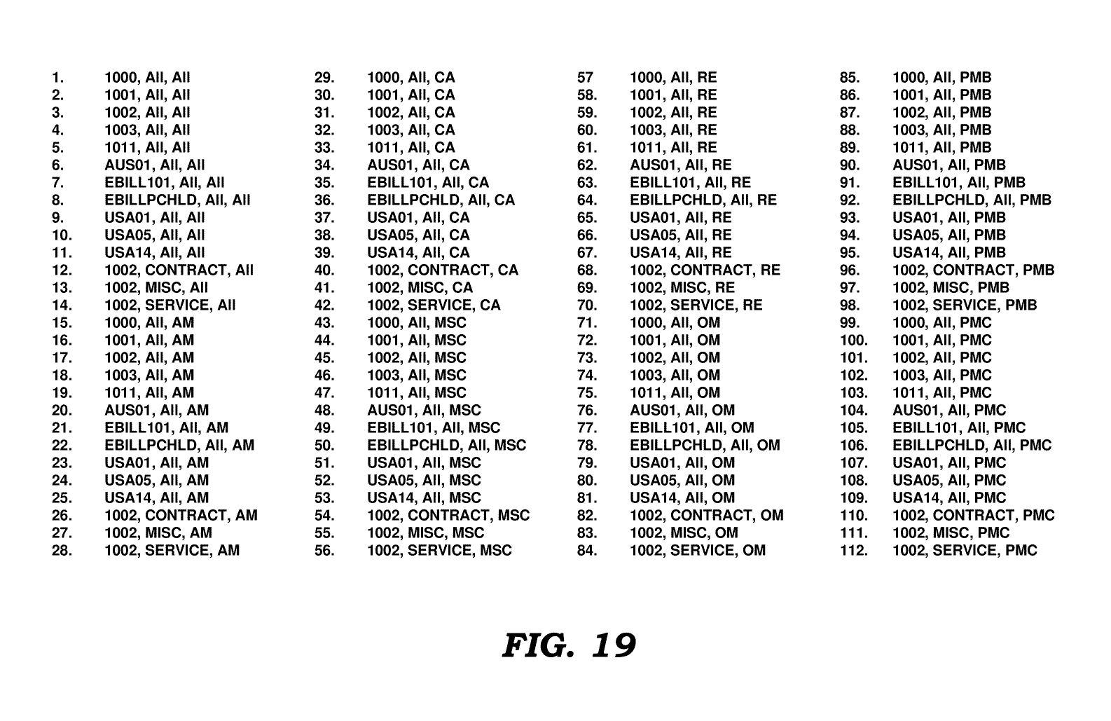

FIG. 19 depicts the cell set for this use case. As may be readily observed, additional records are shown added (compared to that in FIG. 14). Each of the item in the cell set corresponds to the layout of the pivot grid. In this case user has expanded “1002” for “Bill To”, and thus all the “Source” items corresponding to this value are included. Examples of such items in the cell set are: [1002, SERVICE, All], [1002, CONTRACT, All].

Additionally, as the “Bill Type” column is also expanded, causing the corresponding cell set values to be included. Examples of such entries include: [1000, All, AM], [1001, All, AM], [1002, All, AM], [1003, All, AM], [1011, All, AM], etc.

Since the Bill To is also expanded, for Bill To value 1002 with the “Bill Type” expanded is represented as follows in the cell set: [1002, SERVICE, AM], [1002, SERVICE, MSC], [1002, SERVICE, OM, [1002, SERVICE, PMC], etc.

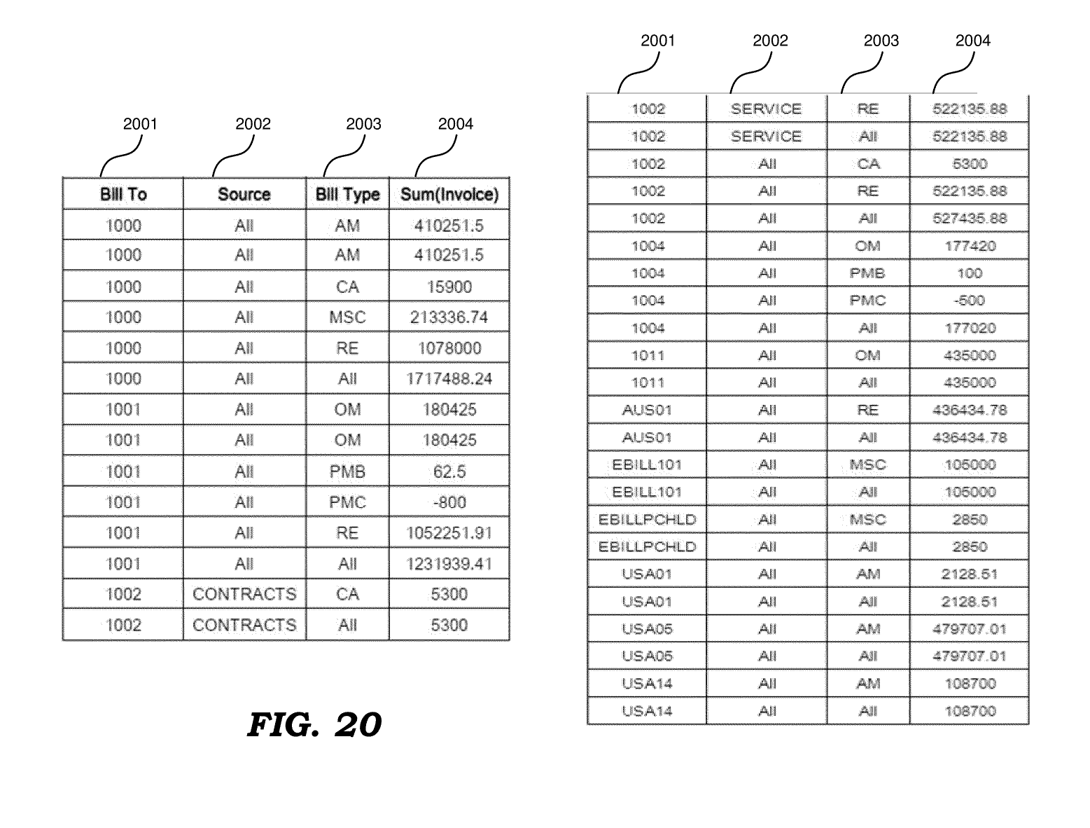

FIG. 20 depicts the records of interest extracted from the output of the second query for use case 2 from the output of the second query. It may be readily observed that the below row became relevant/extracted in view of the expansion of a row (Source Axis=CONTRACTS) and column (BILL TYPE=CA).

| | | Bill | Sum | Group- | Group- | Group- |
|---|---|---|---|---|---|---|
| Bill To | Source | Type | (Invoice) | ing 1 | ing 2 | ing 3 |
| 1002 | CONTRACTS | CA | 5300 | 0 | 0 | 0 |

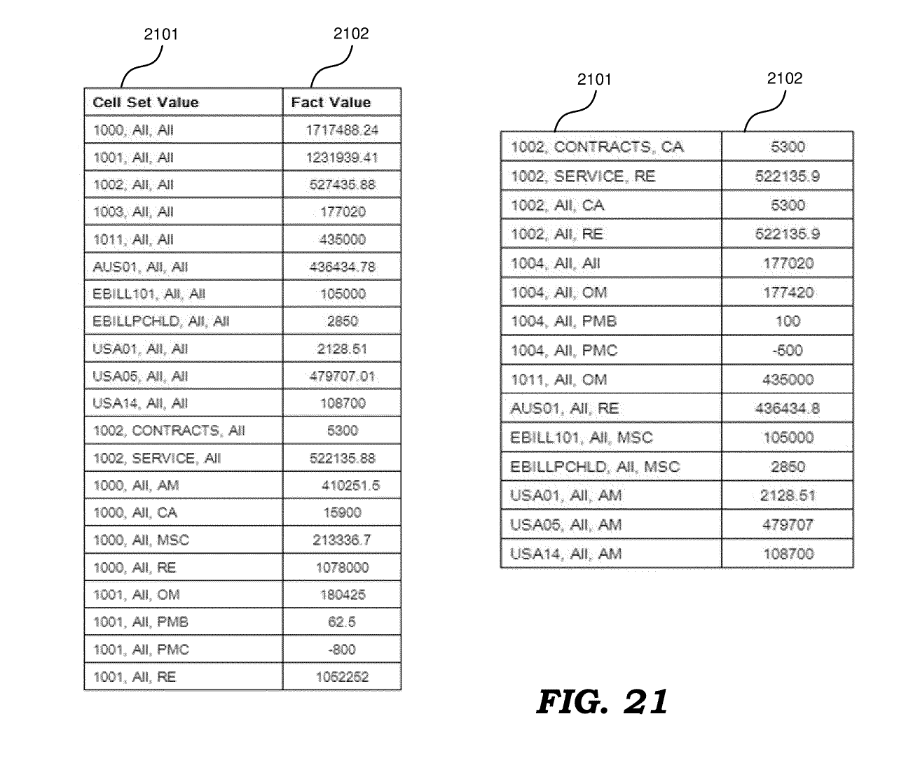

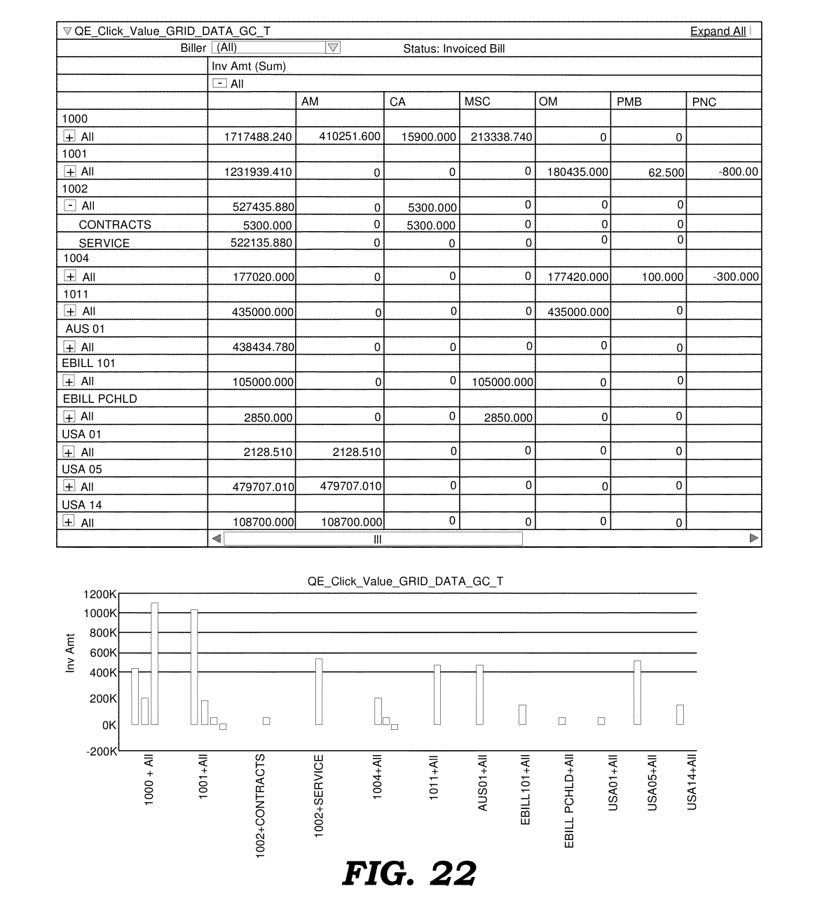

FIG. 21 depicts the cell set with corresponding fact values assigned. FIG. 22 depicts the corresponding display of the pivot view for use case 2. The implementation of view formation block 950 in accordance with FIGS. 21 and 22 will again be apparent to one skilled in the relevant arts, by reading the disclosure provided herein.

### 12. Use Case 3: Addition of a Table Column as a Row Axis

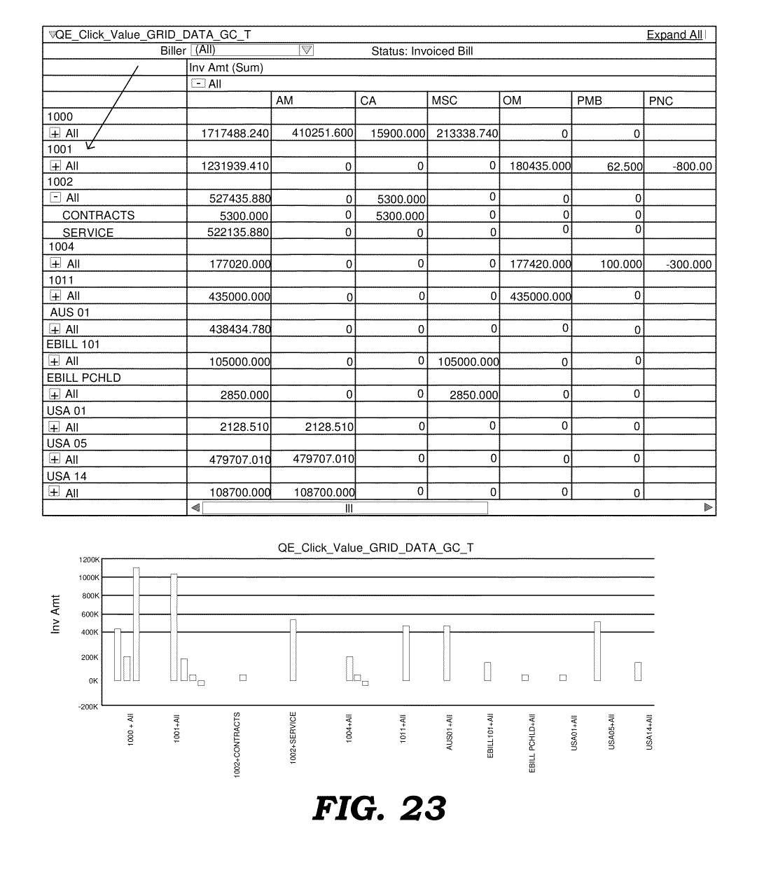

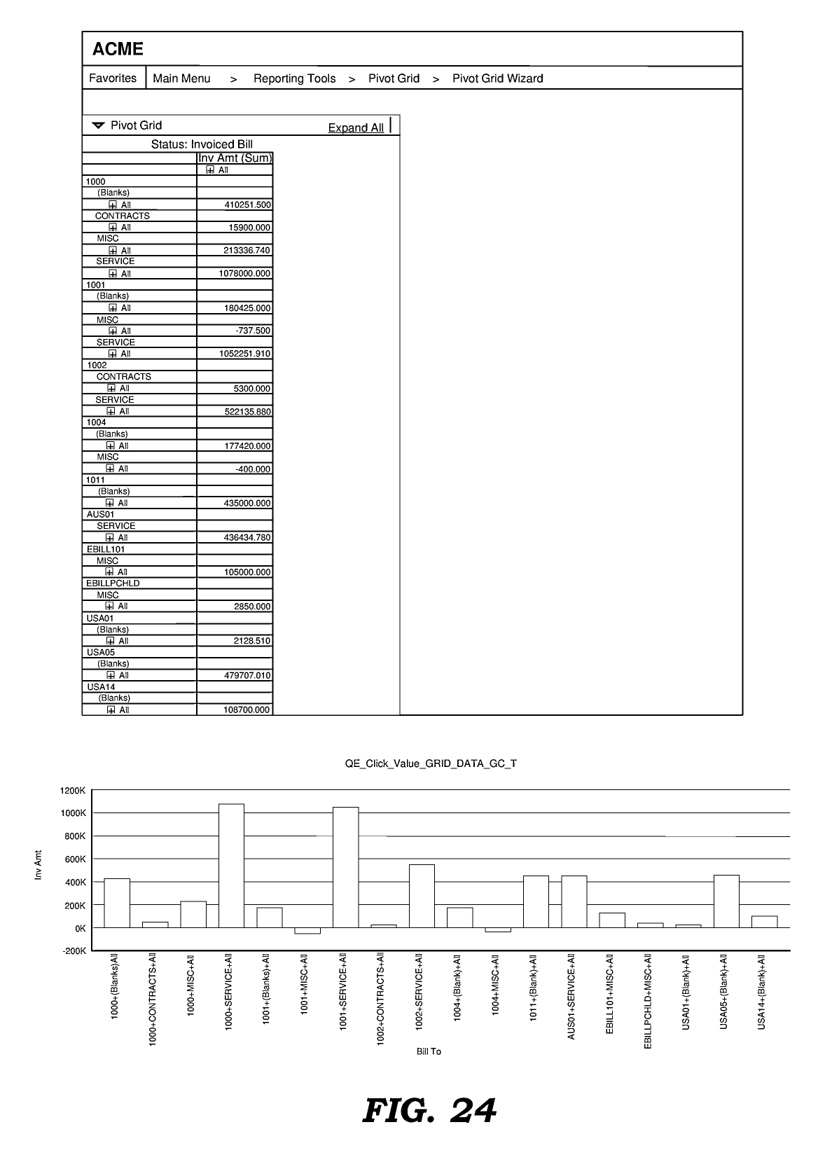

For use case 3, it is assumed that the user has dragged the “Biller” field as a row axis, as depicted in FIG. 23. The effect of such dragging is to add “Biller” to the lowest level detail of row axis hierarchy, as will be clear from the display of FIG. 24. Thus, in FIG. 24, each instance of ‘All’ indicates that a user can request additional detail (at Biller level) by simply expanding the option (i.e., by clicking on+sign there).

In this case as well, the first query to retrieve data remains the same.

The corresponding second query is:
SELECT BILL TO, SOURCE, BILLER, BILL TYPE, SUM(INVOICE AMOUNT),
GROUPING(BILL TO) AS DIM1M,
GROUPING(SOURCE) AS DIM2M,
GROUPING(BILL TYPE) AS DIM3M
FROM TABLENAME
GROUP BY BILL TO, SOURCE, ROLLUP(BILLER), ROLLUP(BILL TYPE);

Compared to the case of use cases 1 and 2, it may be appreciated that the second query BILLER (at lowest level) replacing the SOURCE for the ROLLUP corresponding to the row axis, and the BILLER is shown added to the SELECT clause. As a result, the detailed information at BILLER level is available to view formation block 950, which can be used to assign to corresponding cells of the applicable cell sets. FIG. 24 depicts the corresponding display of the pivot view for use case 3.

### 13. Use Case 4—Addition of a Table Column as a Column Axis

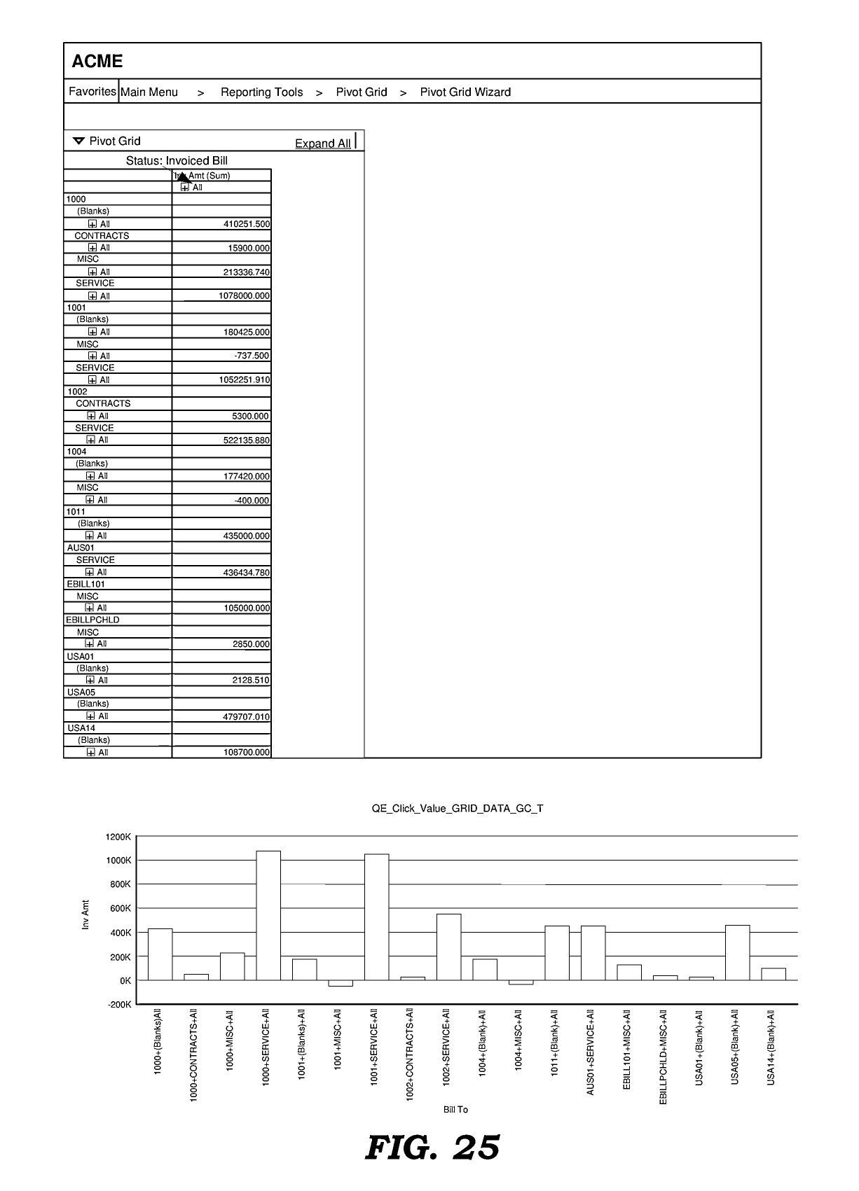

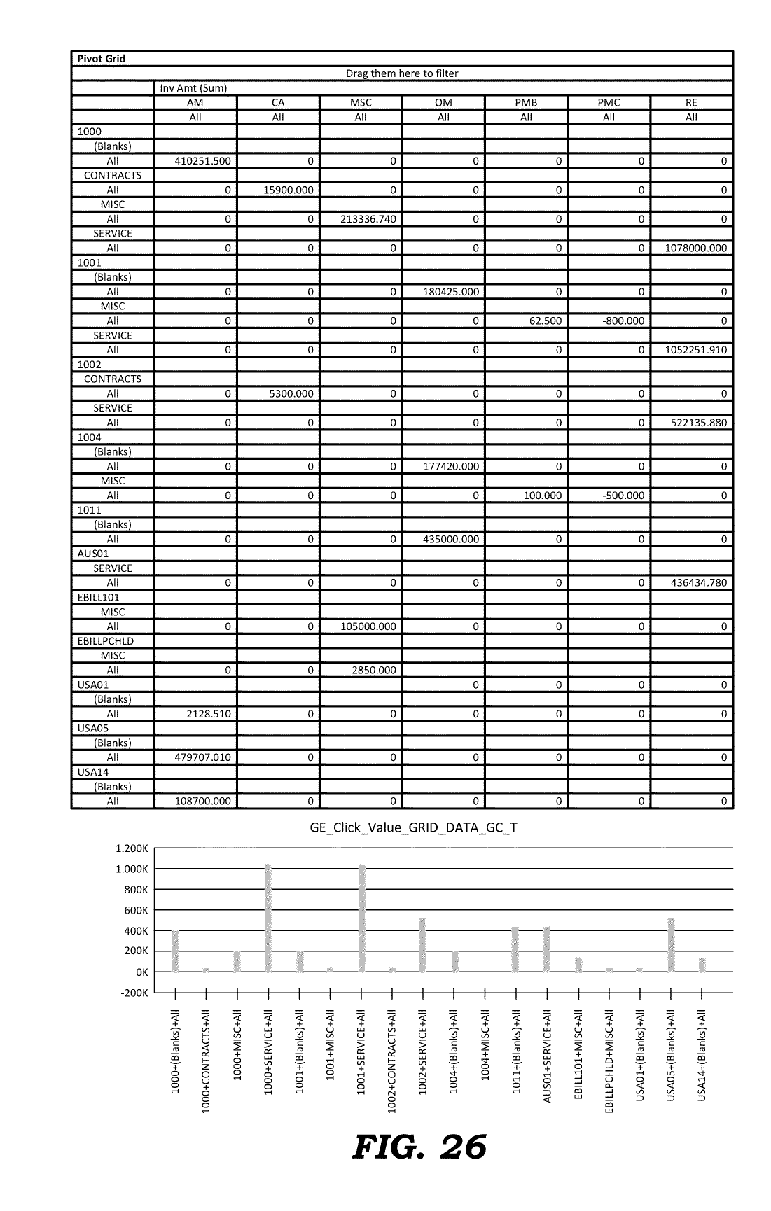

For use case 4, it is assumed that the user has dragged the “Status” field as a column axis, as depicted in FIG. 25. The corresponding second query is:
SELECT BILL TO, SOURCE, BILLER, BILL TYPE, STATUS, SUM (INVOICE AMOUNT),
GROUPING(BILL TO) AS DIM1M,
GROUPING(SOURCE) AS DIM2M,
GROUPING(BILL TYPE) AS DIM3M
FROM TABLENAME
GROUP BY BILL TO, SOURCE, ROLLUP(BILLER), BILL TYPE, ROLLUP(STATUS);

The principle of the query to be executed is explained similar to as use case 3. In particular, ROLLUP is shown applied on STATUS, instead of on BILL TYPE (for column/Y axis). STATUS is also added to the select clause. FIG. 26 depicts the corresponding display of the pivot view for use case 4.

Another aspect of the present disclosure enables users to modify (add or remove) axes of a pivot chart and the display is updated to reflect the modifications, as described below with examples.

### 14. Modifying Axes of Pivot Chart

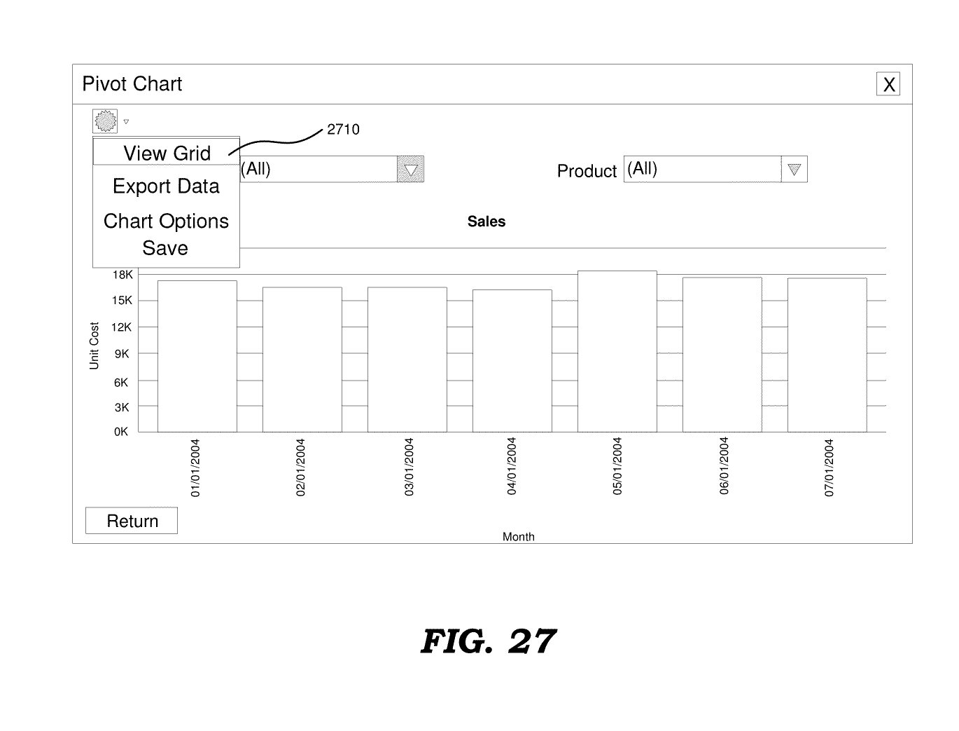

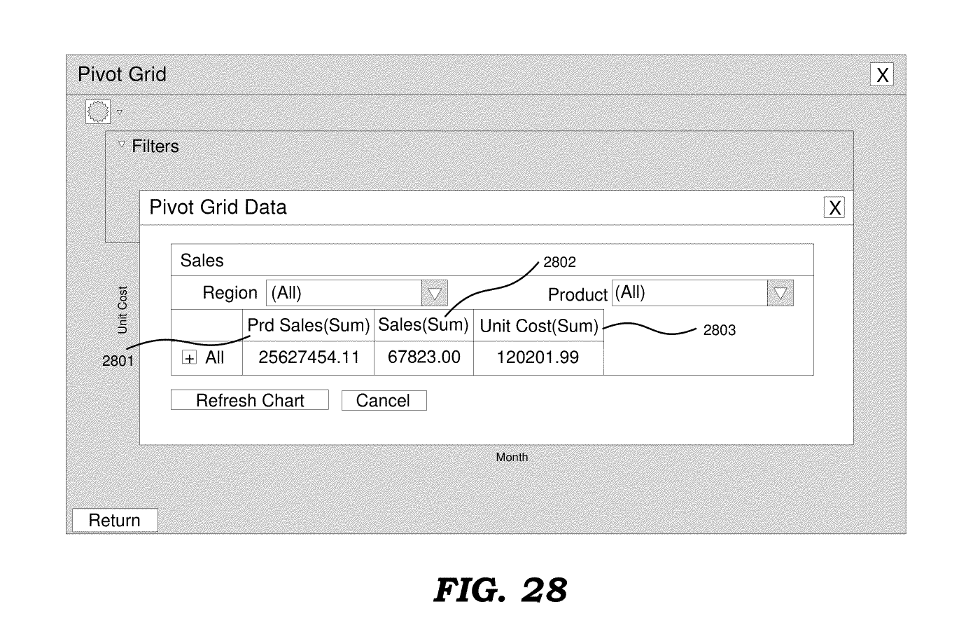

An aspect of the present disclosure enables a user to modify the axes of a pivot chart, as described with examples in relation to FIGS. 27-34. In particular, FIG. 27 depicts a user selecting ‘View Grid’ option (with Unit Cost facts for 7 months) at 2710, and consequently FIG. 28 displaying the grid format representing the same data points/information as in FIG. 27.

It may be appreciated that pivot chart of FIG. 27 has seven months on the X-Axis, and Unit Cost as the fact of interest on Y-axis. On the other hand, pivot grid of FIG. 28, has three column axes, including the one Y-axis (unit cost) of FIG. 27. View formation block 950 displays the three facts (or column axis) based on the view definitions 940, which indicate that the three corresponding fields are value fields.

It may be also observed that the pivot view of FIG. 28 is based on the same data points as that in FIG. 27. In particular, Unit Cost Column Axis 2803 is shown containing 120201.99, which is the sum of the unit costs for the seven months in FIG. 27. Also, the X-axis of the pivot chart is shown presented as row axis of the pivot grid, but in collapsed mode (navigable for expansion).

It is similarly assumed that the same rows of the base tables forming the basis for display, are also used to provide the aggregate values shown displayed for columns 2801 (Prd Sales and Sales) and 2802 as well. In addition, both the pivot chart and pivot grid are shown as containing the same two filter fields (Region and Product).

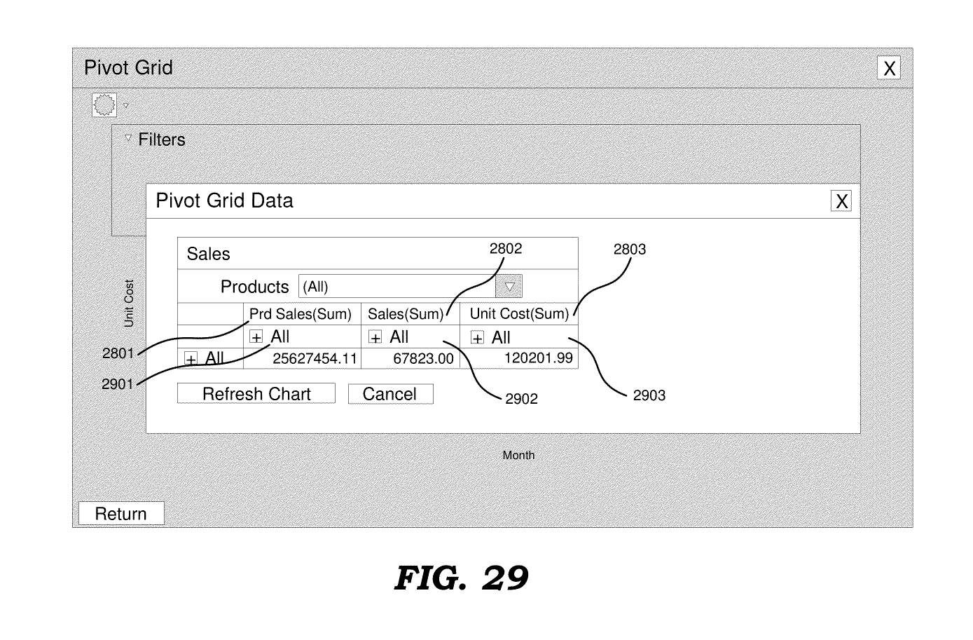

FIG. 29 depicts the display after a user (of FIG. 28) has dropped Region field as a Column axis. Accordingly, the Region is no longer visible as a filter in FIG. 29, but is shown as a corresponding Column Axes in collapsed mode. Though not shown, the user can expand the information corresponding to each of the column axis 2901-2903 for the regions to obtain more detailed information broken by regions for column axis 2801-2803.

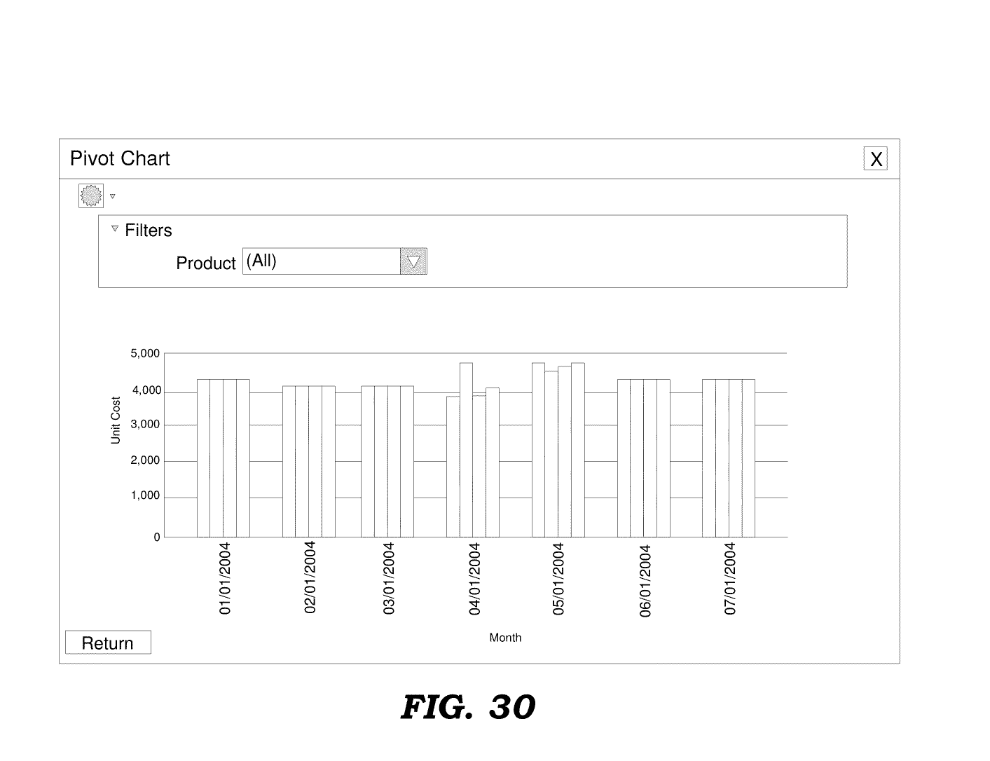

When the user clicks on ‘Refresh Chart’ button, the modifications shown effected in FIGS. 28/29 are reflected in the pivot chart, as depicted in FIG. 30. FIG. 30 contains a series of 4 unit cost values (corresponding to four regions) for each of the 7 months on X-axis, assuming there to be four regions. The filter (Product) from FIG. 29 is shown retained in FIG. 30.

In FIG. 30, the pivot chart corresponding to only Unit Cost fact (of FIG. 29) is shown, since the original pivot chart (of FIG. 27) was shown for Unit Cost. However, the features can be extended to display additional views corresponding to the remaining two facts, at least upon user selection.

The above user experience may be implemented by appropriate modifications to view formation block 950, the corresponding operation of which can be summarized as follows:
1. Display a pivot view for a fact in chart format (per specified axes)
2. Enable a user to modify the axis for the pivot chart
3. Send updated chart for display, corresponding to the modified axis.

While the above example is provided to add only a single axis to a column, more axes can be added, some to the rows as well, as depicted in additional examples below. These features also are implemented by appropriate changes to view formation block 950.

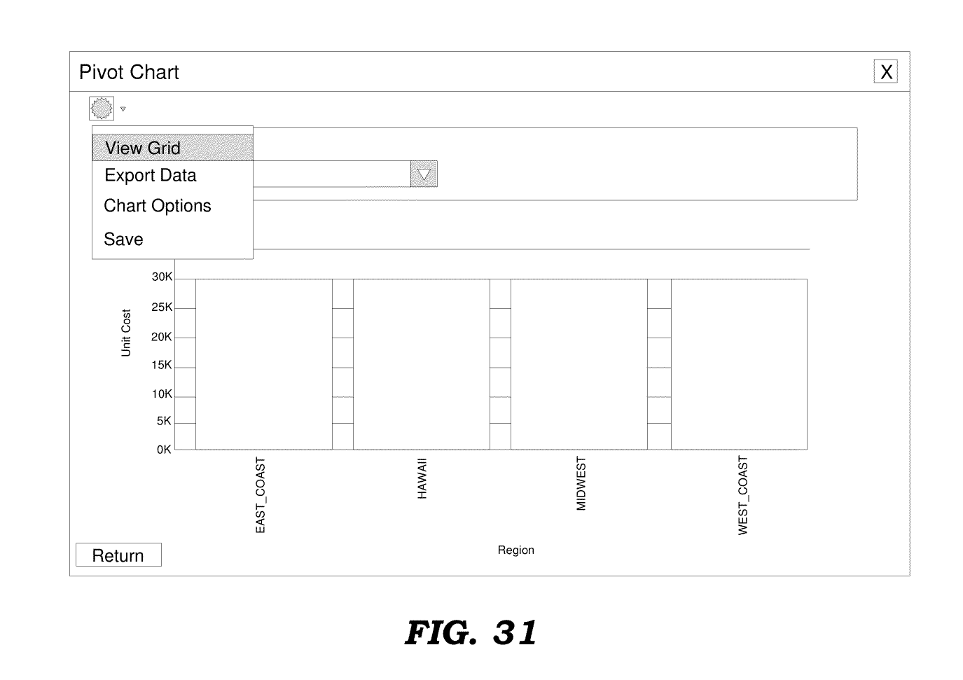

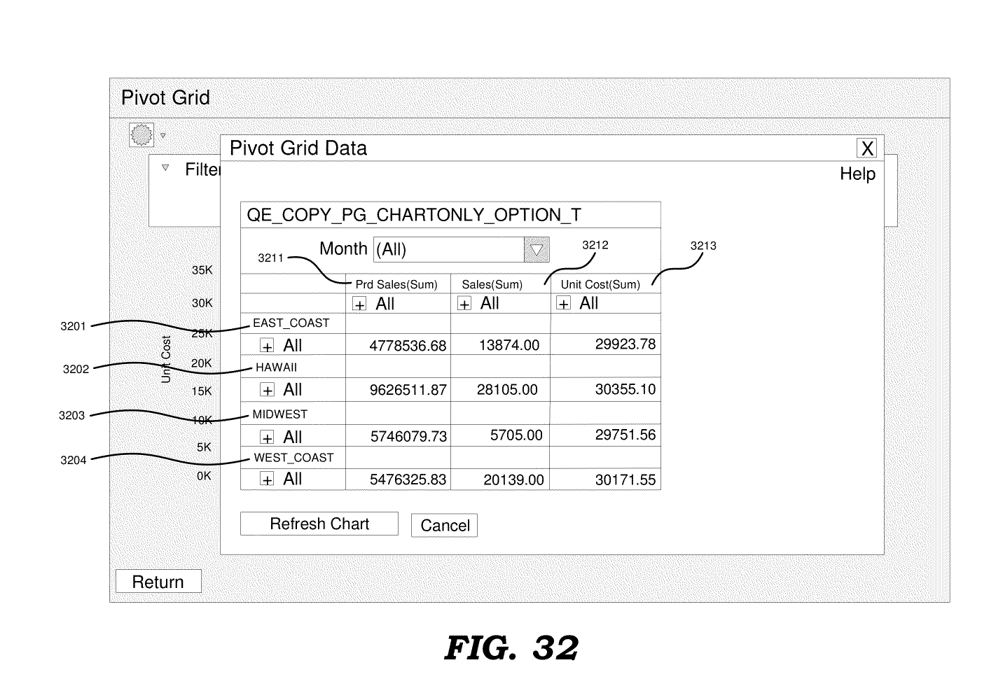

FIG. 31 depicts another pivot view in a chart format, and the user is shown initiating modifications to axes by choosing the ‘View Grid’ option. FIG. 32 depicts the corresponding pivot grid opened as a response. The collapsed column corresponds to ‘Instance’ field, and collapsed row corresponds to ‘Product’ field.

It may be observed that the ‘Region’ on X-axis of the pivot chart is shown as row axis in the pivot grid of FIG. 32, with the details already provided for the four regions. The row axis (region) is shown in expanded form since there is lower (more detailed) level of row axis (product). The region axis is referred to as being at the highest level in the row axis, while the product is referred to as being at a lower level.

Similarly, with respect to the column axis, the fact/value fields corresponding to Prd sales 3211, sales 3212 and unit cost 3213. Additional detail, by instance, for each of the column axes is shown, as being available.

It may be appreciated that there is additional hierarchical information shown in the grid view of FIG. 32, which (level of detail) is not sought to be shown by the schema underlying the pivot chart of FIG. 31. View formation block 950 determines such additional information from view definitions 940. In particular, along the lines of FIG. 11, in the grid axis column there, region and product are assumed to be defined as ‘Row’ axis, and ‘unit cost’, ‘prd sales’, ‘sales,’ and ‘instance’ are assumed to be defined as ‘Column’ axis. As a result, the display of FIG. 32 is generated.

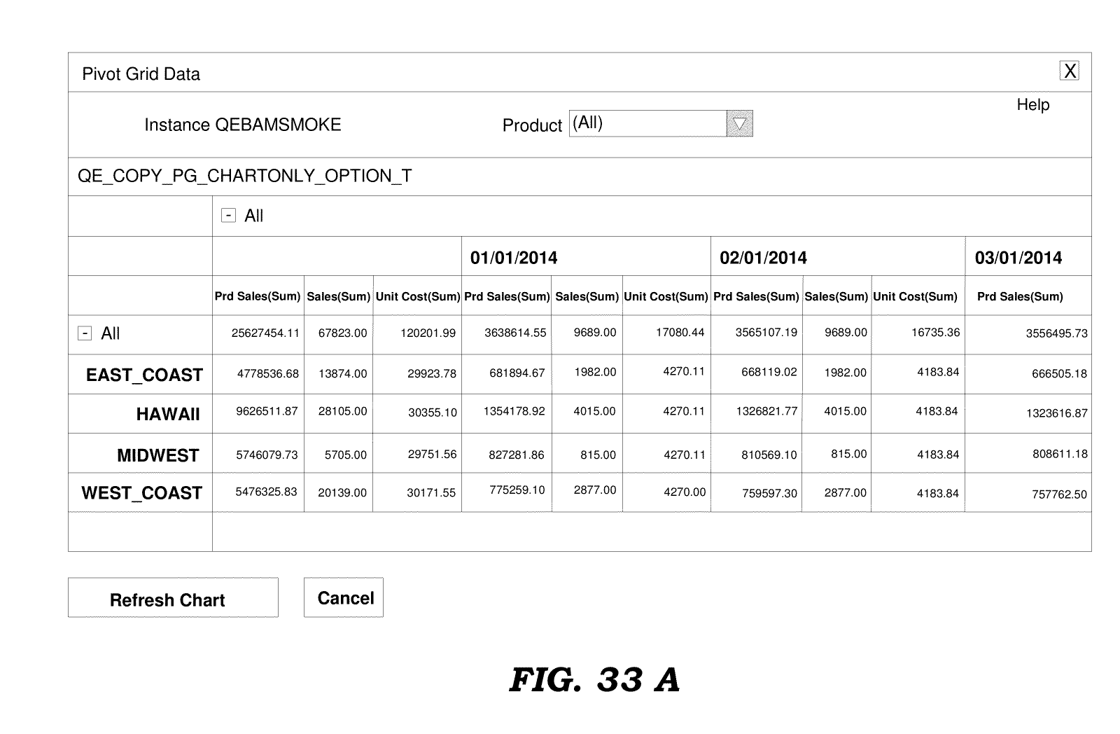

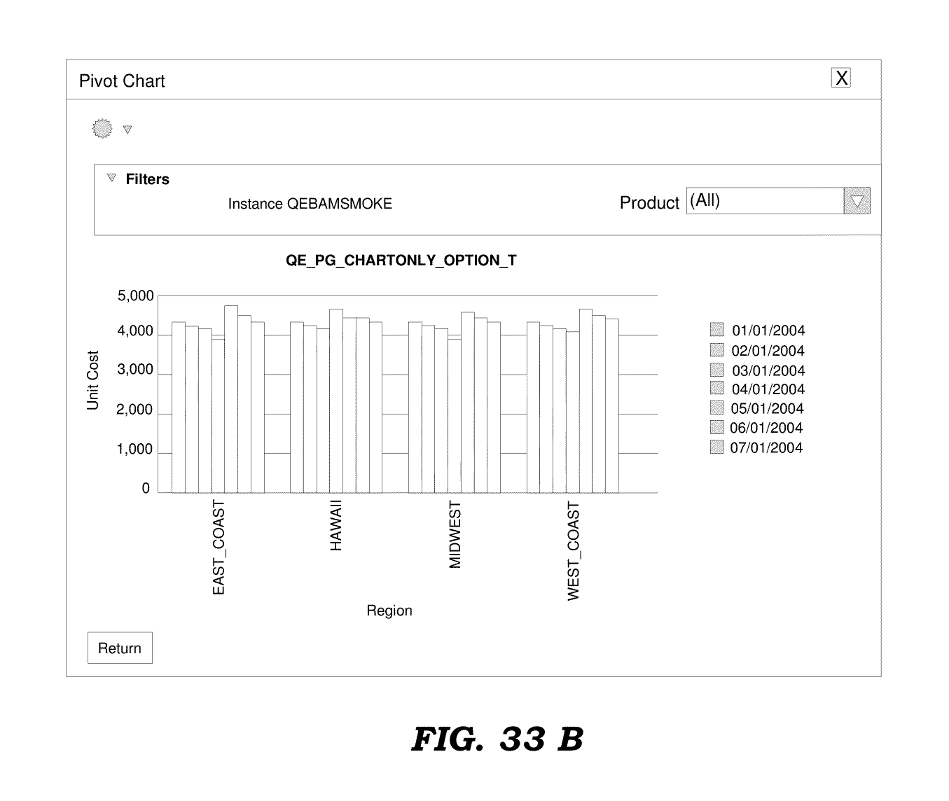

The user is now (with respect to FIG. 32) assumed to have moved the two fields (Instance and Product) as respective filters and move ‘Month’ from filter to Column FIG. 33A depicts the resulting modified grid. Thus, the pivot grid of FIG. 33A is shown with two filters (Instance and Product), and the detail is provided per month. Assuming now that the user selects the ‘Refresh Chart’ option, the display is reverted to pivot chart. FIG. 33B depicts the corresponding modified pivot chart. The series corresponds to 7 months and the Instance and Product fields are depicted as filters. The same X-axis is retained compared to FIG. 32. The description is continued with respect to another example.

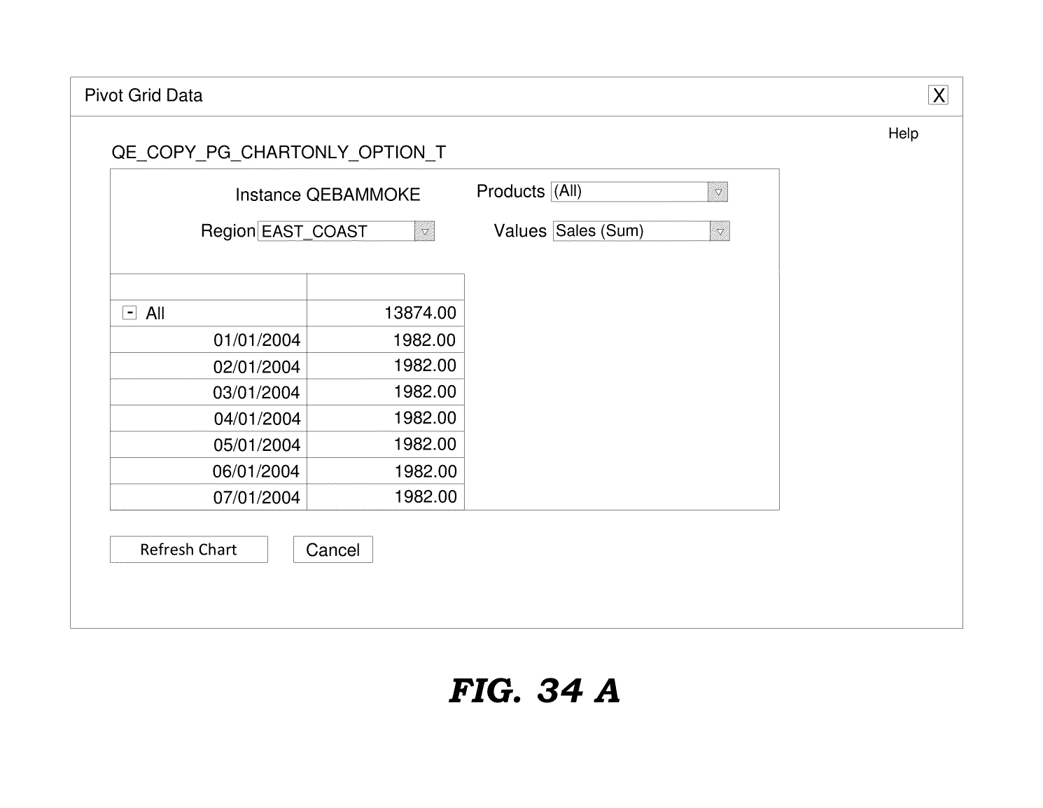

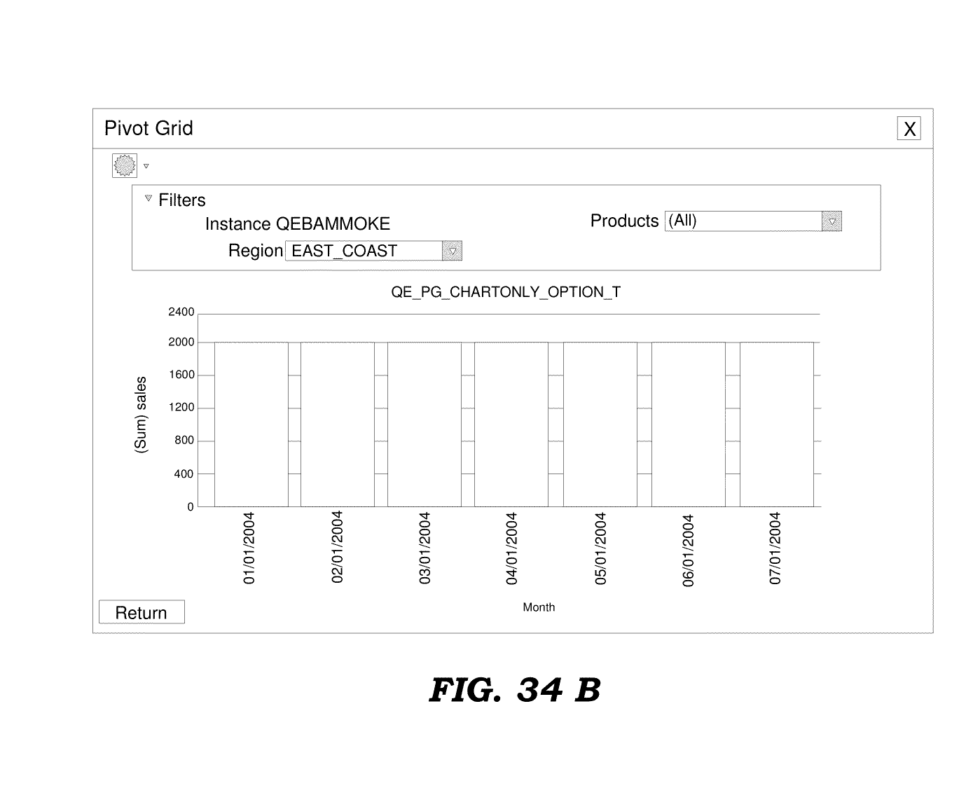

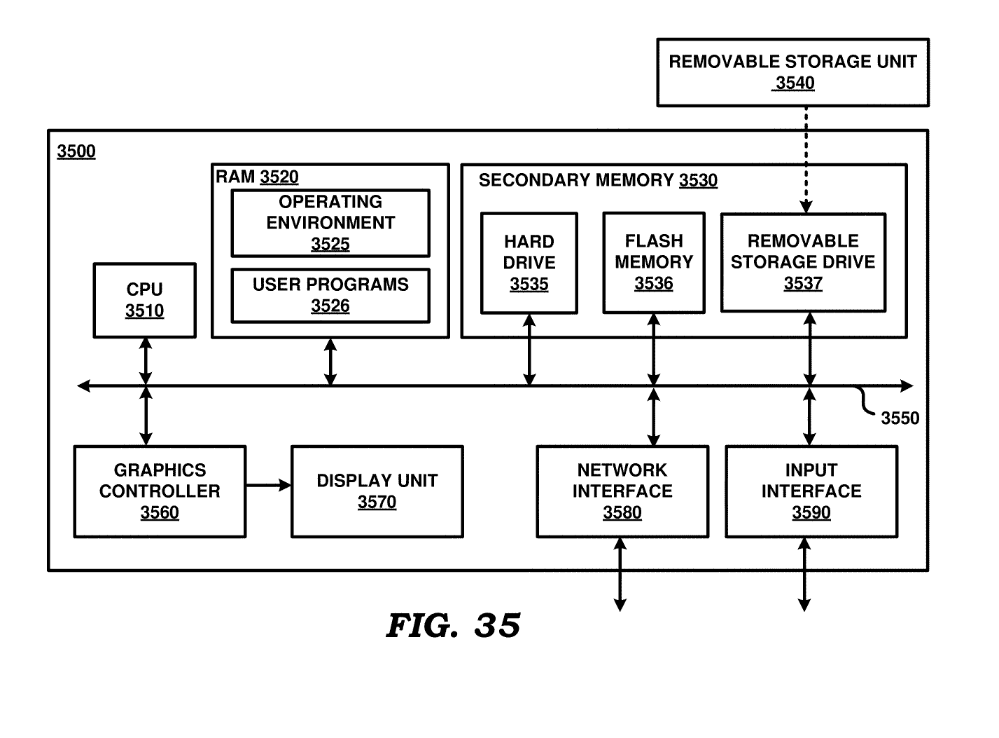

FIG. 34A corresponds to a modified grid after user makes the below noted changes to the grid format of FIG. 33A:

1. User drags Region and makes it a Filter. He selects a value “East Coast” for it;

2. User drags the Month on to the Row Axis; and

3. User drags all the Value/fact fields on to the filter area and selects the “Sales” value.

FIG. 34B depicts corresponding pivot chart, and the following points may be readily observed:

1. The Month field becomes the X axis.

2. The filters Instance, Region and Product are retained. The value selected for the Region filter is retained too.

3. The Value field selected as a filter, “Sales”, becomes the Y Axis.

Thus, there is an option for a user to bring up the grid from a chart only view. User can perform various actions like drag/drop and slicing/filtering of data to change the grid layout. Once the layout is satisfactory, the chart can be synchronized with the grid view.

Since the pivot chart can show only a maximum of two values on the X Axis (X Axis value and Series) and one value on the Y Axis (Selected “Value Field”), the mapping of various types when pivot grid is formed from pivot chart is shown below:

| Chart Axis | Grid Axis - Initial View |
|---|---|
| X Axis value | Highest level on the row of the grid |
| “Values” - One of them is selected as a Y | All the “values” are initially plotted on the |
| Axis | column of the grid |
| Series Value (e.g. the unit cost values | Highest level on the column of the grid |
| provided for each region within a month in | |
| FIG. 30) | |
| Filters on the chart | Filters on the Grid with the same filter |
| | values as that selected on the chart. The |
| | selected values for the Filter are retained |
| | too. |
| All other “axis fields” selected in the model | All the “axis fields” selected in the model |
| (i.e., the configuration/schema stored in | with a valid grid axis will be plotted in the |
| view definitions 940) | row hierarchy i.e. if in the model |
| | definition, the extra “axis” is on the row, it |
| | is plotted as a grid row. If it is on the |
| | column, it is plotted as a grid column If |
| | the grid axis is empty then the “axis field” |
| | is not plotted at all. |

It may be appreciated that the Chart X axis and Series are plotted as grid row and column respectively. All other “axis fields” will be plotted on the axis based on what is defined on the Pivot Grid Model.

Furthermore, based on the displayed pivot grid, user can perform all the usual actions on the grid.
Slicing and filtering of data on the grid
Dragging and dropping on the grid to change the layout
Expanding/Collapsing values on the rows and columns of the grid

Once the grid layout is satisfactory, the user can synchronize the chart with the grid view. When the chart is refreshed, the reverse mapping is done as follows.

| Grid Axis | Chart Axis - Initial View |
|---|---|
| Highest level on the row of the grid | X Axis value |
| “Value fields” on filter | The selected “value field” filter |
| | value is selected as the Y Axis |
| Highest level on the column of the grid | Series Value |
| Filters on the Grid with the same filter | Filters on the chart with the |
| values as that selected on the chart | same filter values as that |
| | selected on the grid |

It may be further noted that since only one X Axis and series is available to be plotted on the chart in a chart-only mode, only the highest level “axis fields” on the row and column of the grid are plotted on the chart. The remaining “axis fields” are ignored and are not plotted on the chart.

In addition, the layout change on the grid which comes up is temporary in nature. They can only be used to synchronize the chart and are not saved anywhere in the data store 160. The Grid and Chart Filters are same and the selected values are synchronized too in the examples of above.

It should be appreciated that the respective features described above with Figure sets 3-8 (first set of techniques), 9-26 (second set) and 27-34 (third set) can be worked in various combinations, as will be apparent to one skilled in the relevant arts. For example, the GROUP BY and ROLLUP constructs of second set can be used for forming views of the publisher and subscriber of first set, and also for the chart/grid views of third set. Similarly, the ability to modify axis of chart of the third set may be applied to view 250 of FIG. 2B.

It should be further appreciated that the features described above can be implemented in various embodiments as a desired combination of one or more of hardware, executable modules, and firmware. The description is continued with respect to an embodiment in which various features are operative when the software instructions described above are executed.

### 15. Digital Processing System

FIG. 35 is a block diagram illustrating the details of digital processing system 3500 in which various aspects of the present disclosure are operative by execution of appropriate software instructions. Digital processing system 3500 may correspond to server system 150 (or any other system in which the various features disclosed above can be implemented).

Digital processing system 3500 may contain one or more processors such as a central processing unit (CPU) 3510, random access memory (RAM) 3520, secondary memory 3530, graphics controller 3560, display unit 3570, network interface 3580, and input interface 3590. All the components except display unit 3570 may communicate with each other over communication path 3550, which may contain several buses as is well known in the relevant arts. The components of FIG. 35 are described below in further detail.

CPU 3510 may execute instructions stored in RAM 3520 to provide several features of the present disclosure described above. CPU 3510 may contain multiple processing units, with each processing unit potentially being designed for a specific task. Alternatively, CPU 3510 may contain only a single general-purpose processing unit.

RAM 3520 may receive instructions from secondary memory 3530 using communication path 3550. RAM 3520 is shown currently containing software instructions constituting shared environment 3525 and/or user programs 3526. Shared environment 3525 includes operating systems, device drivers, virtual machines, etc., which provide a (common) run time environment for execution of user programs 3526.

Graphics controller 3560 generates display signals (e.g., in RGB format) to display unit 3570 based on data/instructions received from CPU 3510. Display unit 3570 contains a display screen to display the images (e.g., those the display screens depicted above) defined by the display signals. Input interface 3590 may correspond to a keyboard and a pointing device (e.g., touch-pad, mouse) and may be used to provide inputs. Network interface 3580 provides connectivity to a network (e.g., using Internet Protocol), and may be used to communicate with other systems (such as those shown in FIG. 1) connected to the network.

Secondary memory 3530 may contain hard drive 3535, flash memory 3536, and removable storage drive 3537. Secondary memory 3530 may store the data and software instructions (e.g., for performing the actions noted above with respect to various user interfaces and flow charts), which enable digital processing system 3500 to provide several features in accordance with the present disclosure.

Some or all of the data and instructions may be provided on removable storage unit 3540, and the data and instructions may be read and provided by removable storage drive 3537 to CPU 3510. Floppy drive, magnetic tape drive, CD-ROM drive, DVD Drive, Flash memory, removable memory chip (PCMCIA Card, EEPROM) are examples of such removable storage drive 3537.

Removable storage unit 3540 may be implemented using medium and storage format compatible with removable storage drive 3537 such that removable storage drive 3537 can read the data and instructions. Thus, removable storage unit 3540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 3540 or hard disk installed in hard drive 3535. These computer program products are means for providing software to digital processing system 3500. CPU 3510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as secondary memory 3530. Volatile media includes dynamic memory, such as RAM 3520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 3550. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 16. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

APPENDIX

| Bill To | Source | Bill Type | Biller | Status | Invoice Amount |
|---|---|---|---|---|---|
| 1004 | | RE | CMT | Invoiced Bill | −76723.390 |
| 1004 | | RE | CMT | Invoiced Bill | −76723.390 |
| FHWA | CONTRACTS | CA | GDE | Invoiced Bill | 0.000 |
| 1004 | | RE | CMT | Invoiced Bill | 75180.830 |
| 1004 | | RE | CMT | Invoiced Bill | 539492.140 |
| BLG01 | BELGIUM | BLG | IOP | Invoiced Bill | 432.000 |
| CAN01 | | OM | PRP | Invoiced Bill | 5671.000 |
| CAN01 | | OM | PRP | Invoiced Bill | 2173.500 |
| 1002 | | RE | CMT | Invoiced Bill | 14000.000 |
| DEU01 | | OM | PRP | Invoiced Bill | 6530.800 |
| FRA01 | | MSC | CMT | Invoiced Bill | 70811.670 |
| FRA98 | | MSC | CMT | Invoiced Bill | 57503.680 |
| FRA01 | MISC | MSC | CMT | Invoiced Bill | 131.560 |
| FRA01 | MISC | MSC | CMT | Invoiced Bill | 143.520 |
| FRA01 | MISC | MSC | CMT | Invoiced Bill | 155.480 |
| DEU01 | MISC | MSC | CMT | Invoiced Bill | 432.000 |
| DEU01 | MISC | MSC | CMT | Invoiced Bill | 442.000 |
| DEU01 | MISC | MSC | CMT | Invoiced Bill | 452.000 |
| FRA01 | MISC | MSC | CMT | Invoiced Bill | 557.170 |
| FRA01 | MISC | MSC | CMT | Invoiced Bill | 569.230 |
| FRA01 | MISC | MSC | CMT | Invoiced Bill | 581.290 |
| FRA01 | MISC | MSC | CMT | Invoiced Bill | 593.350 |
| FRA01 | MISC | MSC | CMT | Invoiced Bill | 545.760 |
| FRA01 | MISC | MSC | CMT | Invoiced Bill | 556.610 |
| FRA01 | MISC | MSC | CMT | Invoiced Bill | 567.460 |
| AUS01 | | OM | PRP | Invoiced Bill | 1650.000 |
| NLD99 | | OM | PRP | Invoiced Bill | 1895.000 |
| BLG01 | | BLG | IOP | Invoiced Bill | 2294.000 |
| BLG01 | BELGIUM | BLG | IOP | Invoiced Bill | 110.000 |
| BLG01 | BELGIUM | BLG | IOP | Invoiced Bill | 127.000 |
| BLG01 | BELGIUM | BLG | IOP | Invoiced Bill | 358.000 |
| BLG01 | BELGIUM | BLG | IOP | Invoiced Bill | 284.000 |
| FRA01 | BELGIUM | BLG | IOP | Invoiced Bill | 321.000 |
| AUS01 | BELGIUM | BLG | IOP | Invoiced Bill | 412.000 |
| AUS01 | MISC | MSC | CMT | Invoiced Bill | 331.000 |
| AUS01 | MISC | MSC | CMT | Invoiced Bill | 341.000 |
| AUS01 | MISC | MSC | CMT | Invoiced Bill | 351.000 |
| FRA01 | MISC | MSC | CMT | Invoiced Bill | 361.000 |
| FRA01 | MISC | MSC | CMT | Invoiced Bill | 371.000 |
| FRA01 | MISC | MSC | CMT | Invoiced Bill | 381.000 |
| FRA01 | MISC | MSC | CMT | Invoiced Bill | 391.000 |
| FRA01 | MISC | MSC | CMT | Invoiced Bill | 402.000 |
| FRA01 | MISC | MSC | CMT | Invoiced Bill | 412.000 |
| DEU01 | MISC | MSC | CMT | Invoiced Bill | 422.000 |
| FRA01 | MISC | MSC | CMT | Invoiced Bill | 167.440 |
| FRA01 | MISC | MSC | CMT | Invoiced Bill | 158.250 |
| FRA01 | MISC | MSC | CMT | Invoiced Bill | 168.800 |
| FRA01 | MISC | MSC | CMT | Invoiced Bill | 179.350 |
| FRA01 | MISC | MSC | CMT | Invoiced Bill | 189.900 |
| FRA01 | MISC | MSC | CMT | Invoiced Bill | 245.180 |
| FRA01 | MISC | MSC | CMT | Invoiced Bill | 257.140 |
| FRA01 | MISC | MSC | CMT | Invoiced Bill | 269.100 |
| FRA01 | MISC | MSC | CMT | Invoiced Bill | 281.060 |
| AUS01 | MISC | MSC | CMT | Invoiced Bill | 321.000 |
| FRA01 | MISC | MSC | CMT | Invoiced Bill | 167.440 |
| FRA01 | MISC | MSC | CMT | Invoiced Bill | 158.250 |
| FRA01 | MISC | MSC | CMT | Invoiced Bill | 168.800 |
| FRA01 | MISC | MSC | CMT | Invoiced Bill | 179.350 |
| FRA01 | MISC | MSC | CMT | Invoiced Bill | 189.900 |
| FRA01 | MISC | MSC | CMT | Invoiced Bill | 245.180 |
| FRA01 | MISC | MSC | CMT | Invoiced Bill | 257.140 |
| FRA01 | MISC | MSC | CMT | Invoiced Bill | 269.100 |
| FRA01 | MISC | MSC | CMT | Invoiced Bill | 281.060 |
| AUS01 | MISC | MSC | CMT | Invoiced Bill | 321.000 |
| AUS01 | MISC | MSC | CMT | Invoiced Bill | 341.000 |
| AUS01 | MISC | MSC | CMT | Invoiced Bill | 351.000 |
| FRA01 | MISC | MSC | CMT | Invoiced Bill | 361.000 |
| FRA01 | MISC | MSC | CMT | Invoiced Bill | 371.000 |
| FRA01 | MISC | MSC | CMT | Invoiced Bill | 381.000 |
| FRA01 | MISC | MSC | CMT | Invoiced Bill | 391.000 |
| FRA01 | MISC | MSC | CMT | Invoiced Bill | 402.000 |
| FRA01 | MISC | MSC | CMT | Invoiced Bill | 412.000 |
| DEU01 | MISC | MSC | CMT | Invoiced Bill | 422.000 |
| DEU01 | MISC | MSC | CMT | Invoiced Bill | 432.000 |
| FRA01 | | OM | PRP | Invoiced Bill | 14.380 |
| FRA04 | REALESTATE | RE | CMT | Invoiced Bill | 44460.910 |
| FRA04 | REALESTATE | RE | CMT | Invoiced Bill | 214243.560 |
| FRAPP115 | REALESTATE | RE | CMT | Invoiced Bill | 6637.800 |
| FRA03 | | MSC | CMT | Invoiced Bill | 1302.000 |
| FRA03 | | MSC | CMT | Invoiced Bill | 2604.000 |
| DEU03 | | MSC | CMT | Invoiced Bill | 17940.000 |
| FRA01 | MISC | MSC | CMT | Invoiced Bill | 131.560 |
| FRA01 | MISC | MSC | CMT | Invoiced Bill | 143.520 |
| FRA01 | MISC | MSC | CMT | Invoiced Bill | 155.480 |
| FRA01 | MISC | MSC | CMT | Invoiced Bill | 158.250 |
| FRA01 | MISC | MSC | CMT | Invoiced Bill | 168.800 |
| FRA01 | MISC | MSC | CMT | Invoiced Bill | 179.350 |
| FRA01 | MISC | MSC | CMT | Invoiced Bill | 189.900 |
| FRA01 | MISC | MSC | CMT | Invoiced Bill | 245.180 |
| FRA01 | MISC | MSC | CMT | Invoiced Bill | 257.140 |
| FRA01 | MISC | MSC | CMT | Invoiced Bill | 269.100 |
| FRA01 | MISC | MSC | CMT | Invoiced Bill | 281.060 |
| AUS01 | MISC | MSC | CMT | Invoiced Bill | 321.000 |
| AUS01 | MISC | MSC | CMT | Invoiced Bill | 331.000 |
| AUS01 | MISC | MSC | CMT | Invoiced Bill | 331.000 |
| AUS01 | MISC | MSC | CMT | Invoiced Bill | 341.000 |
| AUS01 | MISC | MSC | CMT | Invoiced Bill | 351.000 |
| FRA01 | MISC | MSC | CMT | Invoiced Bill | 361.000 |
| FRA01 | MISC | MSC | CMT | Invoiced Bill | 371.000 |
| FRA01 | MISC | MSC | CMT | Invoiced Bill | 381.000 |
| FRA01 | MISC | MSC | CMT | Invoiced Bill | 391.000 |
| FRA01 | MISC | MSC | CMT | Invoiced Bill | 402.000 |
| FRA01 | MISC | MSC | CMT | Invoiced Bill | 412.000 |
| DEU01 | MISC | MSC | CMT | Invoiced Bill | 422.000 |
| FRA01 | MISC | MSC | CMT | Invoiced Bill | 578.310 |
| FRA01 | MISC | MSC | CMT | Invoiced Bill | 594.590 |
| FRA01 | MISC | MSC | CMT | Invoiced Bill | 605.540 |
| FRA01 | MISC | MSC | CMT | Invoiced Bill | 616.490 |
| FRA01 | MISC | MSC | CMT | Invoiced Bill | 627.440 |
| FRA01 | MISC | MSC | CMT | Invoiced Bill | 583.000 |
| DEU99 | | OM | PRP | Invoiced Bill | 1580.000 |
| FRA02 | | OM | PRP | Invoiced Bill | 1911.210 |
| FRA02 | | OM | PRP | Invoiced Bill | 4847.390 |
| FRA02 | | OM | PRP | Invoiced Bill | 1866.120 |
| DEU01 | MISC | MSC | CMT | Invoiced Bill | 432.000 |
| DEU01 | MISC | MSC | CMT | Invoiced Bill | 442.000 |
| DEU01 | MISC | MSC | CMT | Invoiced Bill | 452.000 |
| FRA01 | MISC | MSC | CMT | Invoiced Bill | 557.170 |
| FRA01 | MISC | MSC | CMT | Invoiced Bill | 569.230 |
| FRA01 | MISC | MSC | CMT | Invoiced Bill | 581.290 |
| FRA01 | MISC | MSC | CMT | Invoiced Bill | 593.350 |
| FRA01 | MISC | MSC | CMT | Invoiced Bill | 545.760 |
| FRA01 | MISC | MSC | CMT | Invoiced Bill | 556.610 |
| FRA01 | MISC | MSC | CMT | Invoiced Bill | 567.460 |
| FRA01 | MISC | MSC | CMT | Invoiced Bill | 578.310 |
| FRA01 | MISC | MSC | CMT | Invoiced Bill | 594.590 |
| FRA01 | MISC | MSC | CMT | Invoiced Bill | 605.540 |
| FRA01 | MISC | MSC | CMT | Invoiced Bill | 616.490 |
| FRA01 | MISC | MSC | CMT | Invoiced Bill | 627.440 |
| FRA01 | MISC | MSC | CMT | Invoiced Bill | 583.000 |
| FRA01 | MISC | MSC | CMT | Invoiced Bill | 131.560 |
| FRA01 | MISC | MSC | CMT | Invoiced Bill | 143.520 |
| FRA01 | MISC | MSC | CMT | Invoiced Bill | 155.480 |
| FRA01 | MISC | MSC | CMT | Invoiced Bill | 167.440 |
| 1000 | MISC | MSC | CMT | Invoiced Bill | 92050.000 |
| 1001 | | MSC | FGJ | Invoiced Bill | 9861.580 |
| 1001 | | MSC | FGJ | Invoiced Bill | 21324.170 |
| 1001 | | MSC | FGJ | Invoiced Bill | 21324.170 |
| 1001 | | MSC | FGJ | Invoiced Bill | 9861.580 |
| 1001 | | MSC | FGJ | Invoiced Bill | 350000.000 |
| 1001 | | MSC | FGJ | Invoiced Bill | 700000.000 |
| 1001 | | MSC | FGJ | Invoiced Bill | 14927.140 |
| 1001 | | MSC | FGJ | Invoiced Bill | 21324.170 |
| 1001 | | MSC | FGJ | Invoiced Bill | 9861.580 |
| 1011 | | MSC | CMT | Invoiced Bill | 7855.700 |
| 1002 | | MSC | CMT | Invoiced Bill | 11691.000 |
| US008 | | MSC | GOR | Invoiced Bill | 18147.000 |
| 1001 | | MSC | FGJ | Invoiced Bill | 77773.960 |
| 1002 | | SW | CMT | Invoiced Bill | 20567.500 |
| 1002 | | MSC | CMT | Invoiced Bill | 35000.000 |
| 1000 | | MSC | CMT | Invoiced Bill | 46200.000 |
| FRA01 | MISC | MSC | CMT | Invoiced Bill | 578.310 |
| FRA01 | MISC | MSC | CMT | Invoiced Bill | 594.590 |
| FRA01 | MISC | MSC | CMT | Invoiced Bill | 605.540 |
| FRA01 | MISC | MSC | CMT | Invoiced Bill | 616.490 |
| FRA01 | MISC | MSC | CMT | Invoiced Bill | 627.440 |
| FRA01 | MISC | MSC | CMT | Invoiced Bill | 583.000 |
| FRA05 | | MSC | CMT | Invoiced Bill | 48080.000 |
| GBR01 | | OM | PRP | Invoiced Bill | 1757.250 |
| GBR01 | | OM | PRP | Invoiced Bill | 1698.680 |
| FRA99 | | OM | PRP | Invoiced Bill | 1500.000 |
| JPN01 | | OM | PRP | Invoiced Bill | 16790.000 |
| NLD01 | | OM | PRP | Invoiced Bill | 1809.500 |
| SPN02 | | SPN | CMT | Invoiced Bill | 21530.000 |
| 1001 | | MSC | FGJ | Invoiced Bill | 7825.390 |
| 1001 | | MSC | FGJ | Invoiced Bill | 11443.650 |
| 1001 | | PS | FGJ | Invoiced Bill | 3800.000 |
| 1004 | MISC | PMC | CMT | Invoiced Bill | −500.000 |
| DEU01 | MISC | MSC | CMT | Invoiced Bill | 442.000 |
| DEU01 | MISC | MSC | CMT | Invoiced Bill | 452.000 |
| FRA01 | MISC | MSC | CMT | Invoiced Bill | 557.170 |
| FRA01 | MISC | MSC | CMT | Invoiced Bill | 569.230 |
| FRA01 | MISC | MSC | CMT | Invoiced Bill | 581.290 |
| FRA01 | MISC | MSC | CMT | Invoiced Bill | 593.350 |
| FRA01 | MISC | MSC | CMT | Invoiced Bill | 545.760 |
| FRA01 | MISC | MSC | CMT | Invoiced Bill | 556.610 |
| FRA01 | MISC | MSC | CMT | Invoiced Bill | 567.460 |
| 1002 | | SW | CMT | Invoiced Bill | 1000000.000 |
| 1008 | MISC | PMC | GDE | Invoiced Bill | −1000.000 |
| 1001 | CONTRACTS | CA | FGJ | Invoiced Bill | 175101.570 |
| 1000 | MISC | PMC | CMT | Invoiced Bill | −212.000 |
| 1000 | MISC | PMC | CMT | Invoiced Bill | −3498.000 |
| 1001 | CONTRACTS | CA | FGJ | Invoiced Bill | 55000.000 |
| 1001 | | MSC | FGJ | Invoiced Bill | 21324.170 |
| 1001 | | MSC | FGJ | Invoiced Bill | 9861.580 |
| 1001 | | MSC | FGJ | Invoiced Bill | 21324.170 |
| GBR03 | | MSC | CMT | Invoiced Bill | 14280.000 |
| 1001 | | MSC | FGJ | Invoiced Bill | 19000.000 |
| 1001 | | MSC | FGJ | Invoiced Bill | 19000.000 |
| 1001 | | MSC | FGJ | Invoiced Bill | 19000.000 |
| 1001 | | MSC | FGJ | Invoiced Bill | 19000.000 |
| 1001 | | OM | FGJ | Invoiced Bill | 600.000 |
| 1002 | | OM | PRP | Invoiced Bill | 840.000 |
| 1008 | | OM | GDE | Invoiced Bill | 420.000 |
| 1008 | | OM | GDE | Invoiced Bill | 2400.000 |
| USA01 | | OM | GOR | Invoiced Bill | 1002.670 |
| USA01 | | OM | GOR | Invoiced Bill | 119.350 |
| 1000 | | AM | CMT | Invoiced Bill | 1275.750 |
| 1002 | SERVICE | RE | CMT | Invoiced Bill | 497135.880 |
| 1001 | | MSC | FGJ | Invoiced Bill | 9861.580 |
| 1001 | SERVICE | RE | FGJ | Invoiced Bill | 5890.000 |
| USA98 | | MSC | CMT | Invoiced Bill | 19000.000 |
| 1003 | | MSC | 10P | Invoiced Bill | 11875.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| 1002 | OES | OM | PRP | Invoiced Bill | 2915630.000 |
| 1003 | | OM | 10P | Invoiced Bill | 26750.000 |
| 1002 | | OM | PRP | Invoiced Bill | 793.000 |
| 1001 | | OM | FGJ | Invoiced Bill | 500.000 |
| 1001 | | OM | FGJ | Invoiced Bill | 250.000 |
| 1001 | | OM | FGJ | Invoiced Bill | 600.000 |
| 1002 | | OM | PRP | Invoiced Bill | 960.000 |
| 1001 | | OM | FGJ | Invoiced Bill | 3960.000 |
| 1001 | | OM | FGJ | Invoiced Bill | 176225.000 |
| 1004 | | OM | PRP | Invoiced Bill | 21080.000 |
| 1004 | | OM | PRP | Invoiced Bill | 10540.000 |
| 1001 | | OM | FGJ | Invoiced Bill | 4200.000 |
| 1004 | | OM | PRP | Invoiced Bill | 11250.000 |
| 1001 | CONTRACTS | PC | FGJ | Invoiced Bill | 1500000.000 |
| 1004 | | RE | CMT | Invoiced Bill | 76723.390 |
| 1004 | | RE | CMT | Invoiced Bill | 76723.390 |
| 1000 | | RE | CMT | Invoiced Bill | 10800.000 |
| 1008 | | OM | GDE | Invoiced Bill | 781.920 |
| 1008 | | OM | GDE | Invoiced Bill | 3031.010 |
| USA01 | | OM | GOR | Invoiced Bill | 1100.000 |
| USA01 | | OM | GOR | Invoiced Bill | 2370.000 |
| USA04 | | OM | GOR | Invoiced Bill | 288.590 |
| USA04 | | OM | GOR | Invoiced Bill | 1679.040 |
| USA14 | | OM | CMT | Invoiced Bill | 840.000 |
| USA14 | | OM | CMT | Invoiced Bill | 1824.000 |
| USA04 | | OM | GOR | Invoiced Bill | 1415.100 |
| USA14 | | OM | CMT | Invoiced Bill | 1050.000 |
| USA05 | MISC | CA | GDE | Invoiced Bill | 19000.000 |
| USA05 | MISC | CA | GDE | Invoiced Bill | 19000.000 |
| 1004 | MISC | PMB | CMT | Invoiced Bill | 100.000 |
| 1001 | MISC | PMB | FGJ | Invoiced Bill | 62.500 |
| 1001 | MISC | PMC | FGJ | Invoiced Bill | −800.000 |
| 1008 | OES | MSC | GDE | Invoiced Bill | 4593.020 |
| 1005 | OES | MSC | CMT | Invoiced Bill | 745.150 |
| 1001 | | OM | FGJ | Invoiced Bill | 35000.000 |
| 1001 | | RE | FGJ | Invoiced Bill | 14100.000 |
| 1004 | | RE | CMT | Invoiced Bill | 76723.390 |
| 1000 | SERVICE | RE | CMT | Invoiced Bill | 1064000.000 |
| 1001 | SERVICE | RE | FGJ | Invoiced Bill | 825976.400 |
| 1008 | | OM | GDE | Invoiced Bill | 32310.000 |
| 1008 | | OM | GDE | Invoiced Bill | 323100.000 |
| 1000 | OM | OM | CMT | Invoiced Bill | 3975.000 |
| 1000 | OM | OM | CMT | Invoiced Bill | 3180.000 |
| 1000 | OM | OM | CMT | Invoiced Bill | 4770.000 |
| 1000 | OM | OM | CMT | Invoiced Bill | 1987.500 |
| 1000 | OM | OM | CMT | Invoiced Bill | 19080.000 |
| 1011 | | OM | PRP | Invoiced Bill | 500.000 |
| 1011 | | OM | PRP | Invoiced Bill | 435000.000 |
| 1004 | | OM | PRP | Invoiced Bill | 134550.000 |
| EBILLPCHLD | MISC | MSC | CMT | Invoiced Bill | 2850.000 |
| EBILL101 | MISC | MSC | CMT | Invoiced Bill | 87500.000 |
| USA14 | | AM | CMT | Invoiced Bill | 108700.000 |
| 1020 | CONTRACTS | GM | FGJ | Invoiced Bill | 600000000.000 |
| 1018 | CONTRACTS | GM | GDE | Invoiced Bill | 6000000.000 |
| 1000 | MISC | MSC | CMT | Invoiced Bill | 213336.740 |
| 1018 | CONTRACTS | GM | GDE | Invoiced Bill | 40400.000 |
| 1000 | CONTRACTS | CA | CMT | Invoiced Bill | 15900.000 |
| 1000 | | AM | CMT | Invoiced Bill | 400700.000 |
| USA01 | | AM | GOR | Invoiced Bill | 1408.570 |
| USA05 | | AM | GDE | Invoiced Bill | 232693.710 |
| 1000 | | AM | CMT | Invoiced Bill | 7000.000 |
| USA05 | | AM | GDE | Invoiced Bill | 166541.650 |
| 1002 | CONTRACTS | CA | PRP | Invoiced Bill | 5300.000 |
| USA01 | | AM | GOR | Invoiced Bill | 359.970 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| USA05 | MISC | CA | GDE | Invoiced Bill | 19000.000 |
| 1002 | | OM | PRP | Invoiced Bill | 11100.000 |
| CAN03 | | PC | POL | Invoiced Bill | 4720.000 |
| CAN02 | | PC | POL | Invoiced Bill | 3000000.000 |
| 1001 | | MSC | FGJ | Invoiced Bill | 5673.380 |
| 1002 | | MSC | CMT | Invoiced Bill | 35000.000 |
| 1007 | | OM | GOR | Invoiced Bill | 57400.000 |
| AUS01 | SERVICE | RE | CMT | Invoiced Bill | 436434.780 |
| 1001 | SERVICE | RE | FGJ | Invoiced Bill | 209509.510 |
| 1002 | SERVICE | RE | CMT | Invoiced Bill | 25000.000 |
| 1000 | SERVICE | RE | CMT | Invoiced Bill | 14000.000 |
| 1001 | SERVICE | RE | FGJ | Invoiced Bill | 10876.000 |
| USA05 | | AM | GDE | Invoiced Bill | 80471.650 |
| 1000 | | AM | CMT | Invoiced Bill | 1275.750 |
| USA01 | | AM | GOR | Invoiced Bill | 359.970 |
| FHWA | CONTRACTS | CA | GDE | Invoiced Bill | 28000.000 |
| EBILL101 | MISC | MSC | CMT | Invoiced Bill | 17500.000 |

What is claimed is:

1. A method of displaying pivot views from data stored in base tables, the method comprising:
enabling a user to specify a first pivot view as a publisher upon change of a criteria for selection of data points, and a second pivot view as a subscriber upon occurrence of the change;
sending for display the first view and the second view;
detecting occurrence of an event representing the change of the criteria in the first pivot view;
selecting data elements from a base table constrained by the changed criteria; and
updating both the first view and the second view based on the selected data elements in response to the detecting.

2. The method of claim 1, wherein said first view contains a filter based on a table column of said base table common to both of said first pivot view and said second pivot view, wherein said event represents a value being specified for said filter, wherein those of said data elements matching said value are selected for inclusion in said first view and said second view.

3. The method of claim 2, wherein said first pivot view is based on a first set of axis fields which is different from a second set of axis fields said second pivot view is based on, such that the user can examine data points in desired dimensions while having changes to said filter effected in both views though said filter is changed only in said first pivot view.

4. The method of claim 3, wherein said first pivot view contains a grid view and said second pivot view contains a chart view.

5. The method of claim 1, wherein the base table is stored in a relational database storing a plurality of tables including the base table, wherein the method further comprises forming a cell set of aggregated values of a value field corresponding to each element of the first pivot view, wherein the forming comprises:
executing a first query containing a GROUP BY construct of all of a plurality of axis fields defining said first pivot view to identify a first set of rows having unique combinations of axis values for said axis fields in said base table;
identifying unique values in said first set of rows for each of said plurality of axis fields, wherein each combination of unique values for the respective axis fields defines a corresponding position in said cell set;
executing a second query containing a GROUPBY on a set of fields, wherein said set of fields contains a respective ROLLUP construct on the axis fields at the lowest level of hierarchy in each dimension and the remaining ones of said plurality of axis fields, wherein execution of said second query generates a corresponding set of aggregate values;
assigning to each position of said cell set a corresponding aggregated value generated by said second query to form said first pivot view.

6. The method of claim 5, wherein said pivot view is defined based on a first set of axis fields in a first duration and based on a second set of axis fields in a second duration,
in said first duration, said first query and said second query are executed with said first set of axis fields as said plurality of fields,
in said second duration, said first query and said second query are executed with said second set of axis fields as said plurality of fields.

7. The method of claim 6, wherein said second set of axis fields are formed by addition to or removal of one field from said first set of axis fields, wherein said second view is formed upon receiving a corresponding user request to add or remove said one field from said first pivot view.

8. The method of claim 1, further comprising:
displaying a pivot chart of said first pivot view;
enabling a user to modify the axis for the pivot chart; and
sending an updated chart for display, corresponding to the modified axis.

9. The method of claim 8, wherein said pivot chart is displayed at a first time instance, wherein said enabling comprises:
receiving a request from a user to provide a grid view for said chart at a second time instance following said first time instance;
displaying said grid view for said chart representing the same data as that represented by said pivot chart;
receiving change data representing modification of at least one axis in said grid view;
displaying said grid view with said modification, as modified grid;
converting said modified grid view to a modified chart,
wherein said modified chart is sent as said updated chart for display reflecting the modification.

10. The method of claim 9, wherein said pivot chart displays a first axis field along X-axis and a second axis field along Y-axis, said second axis field being defined as a value field in a schema of said first pivot view, said method further comprising forming said grid view corresponding to said pivot chart, said forming comprises:
setting said first axis field as the highest level row axis of said pivot grid, said value field being set as a column axis of said pivot grid.

11. The method of claim 10, wherein said pivot chart contains a first set of filters and a series values along said X-axis, said forming further comprises:
setting an axis field corresponding to said series values as highest level of column axis of said pivot grid, wherein said value field is set to a lower level than said series values, and
wherein said filters and associated values are propagated to said pivot grid.

12. The method of claim 10, wherein said schema of said first pivot view contains a third set of axis fields which are not basis for display of said pivot chart, said forming further comprising:
setting each of said third set of axis fields as corresponding row axis or column axis as defined in said schema, wherein the field is added at lower levels of hierarchy.

13. The method of claim 9, wherein said modified grid comprises a fourth set of axis fields as row axes and a fifth set of axis fields are column axes, with a fifth field of said fifth set of axis fields being a value field and a sixth field of said fourth set being at a highest level in row axes of said modified grid, said converting comprises:
setting said sixth field as X-axis of said modified chart; and
setting said fifth field as Y-axis of said modified chart.

14. The method of claim 13, wherein said modified grid comprises a seventh field of said fifth set of axis fields as a highest level field in column axes, said converting comprises:
setting said seventh field as a series value of said modified chart.

15. A non-transitory machine readable medium storing one or more sequences of instructions for enabling a digital processing system to display pivot views from data stored in base tables, wherein execution of said one or more instructions by one or more processors contained in said digital processing system causes said digital processing system to perform the actions of:
displaying a pivot chart of said first pivot view;
enabling a user to modify the axis for the pivot chart; and
sending an updated chart for display, corresponding to the modified axis.

16. The non-transitory machine readable medium of claim 15, wherein said pivot chart is displayed at a first time instance, wherein said enabling comprises:
receiving a request from a user to provide a grid view for said chart at a second time instance following said first time instance;
displaying said grid view for said chart representing the same data as that represented by said pivot chart;
receiving change data representing modification of at least one axis in said grid view;
displaying said grid view with said modification, as modified grid;
converting said modified grid view to a modified chart,
wherein said modified chart is sent as said updated chart for display reflecting the modification.

17. The non-transitory machine readable medium of claim 16, wherein said pivot chart displays a first axis field along X-axis and a second axis field along Y-axis, said second axis field being defined as a value field in a schema of said first pivot view, said method further comprising forming said grid view corresponding to said pivot chart, said forming comprises:
setting said first axis field as the highest level row axis of said pivot grid, said value field being set as a column axis of said pivot grid.

18. The non-transitory machine readable medium of claim 16, wherein said modified grid comprises a fourth set of axis fields as row axes and a fifth set of axis fields are column axes, with a fifth field of said fifth set of axis fields being a value field and a sixth field of said fourth set being at a highest level in row axes of said modified grid, said converting comprises:
setting said sixth field as X-axis of said modified chart; and
setting said fifth field as Y-axis of said modified chart.

19. A digital processing system for generating pivot views based on a base table of a relational database, said digital processing system comprising:
a memory storing instructions;
a processor to retrieve said instructions from said memory and execute the retrieved instructions, wherein execution of said instructions causes said digital processing system to perform the actions of:
executing on said relational database, a first query containing a GROUP BY construct of all of a plurality of axis fields defining a first pivot view to identify a first set of rows having unique combinations of axis values for said axis fields in said base table;
identifying unique values in said first set of rows for each of said plurality of axis fields, wherein each combination of unique values for the respective axis fields defines a corresponding position in said cell set;
executing on said relational database, a second query containing a GROUPBY on a set of fields, wherein said set of fields contains a respective ROLLUP construct on the axis fields at the lowest level of hierarchy in each dimension and the remaining ones of said plurality of axis fields, wherein execution of said second query generates a corresponding set of aggregate values;
assigning to each position of said cell set a corresponding aggregated value generated by said second query to form said first pivot view; and
displaying said first pivot view.

20. The digital processing system of claim 19, wherein said pivot view is defined based on a first set of axis fields in a first duration and based on a second set of axis fields in a second duration,
in said first duration, said first query and said second query are executed with said first set of axis fields as said plurality of fields,
in said second duration, said first query and said second query are executed with said second set of axis fields as said plurality of fields.
